(19) United States
(12) Patent Application Publication
(10) Pub. No.: US 2025/0238487 A1
(43) Pub. Date: Jul. 24, 2025

(54) LCS PROCESSING FEATURE ACCESS CONTROL SYSTEM

(71) Applicant: Dell Products L.P., Round Rock, TX (US)

(72) Inventors: Douglas Lang Farley, Round Rock, TX (US); Srinivas Giri Raju Gowda, Fremont, CA (US); David Craig Lawson, Richardson, TX (US); Trevor Christian Cockrell, Hutto, TX (US); Shawn Mathew Swanson, Chanhassen, MN (US)

(21) Appl. No.: 18/415,914

(22) Filed: Jan. 18, 2024

(51) Int. Cl. G06F 21/10

(52) U.S. Cl. CPC G06F 21/107; G06F 21/1011

(57) ABSTRACT

An LCS processing feature access control system includes a resource management system coupled to a processing system including a plurality of processing subsystems. The resource management system receives a first LCS request to provide a first LCS, and provides the first LCS using a first subset of the processing subsystems. The resource management system also receives a second LCS request to provide a second LCS, and provides the second LCS using a second subset of the processing subsystems that is different than the first subset of the processing subsystems, The resource management system then receives a first LCS feature access request to provide access for the first LCS to a processing feature that is not available via the first subset of the processing subsystems, and provides the first LCS using a third subset of the processing subsystems that is different than the first subset and that provides the processing feature.

### BACKGROUND

The present disclosure relates generally to information handling systems, and more particularly to controlling access to processing features of a processing system in an information handling system that provides Logically Composed Systems (LCSs).

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices, may be used to provide users with Logically Composed Systems (LCSs) that include logical systems that perform workloads using the components in one or more server devices. The provisioning of LCSs using components like processing systems in server devices presents issues with regard to the utilization of processing system service features like “Silicon as-a-service” (Si-aaS), which one of skill in the art in possession of the present disclosure will recognize conventionally allows a customer purchasing a server device to pay to enable different processing features of the processing system in that server device depending on their needs. However, with conventional processing systems, the enablement of any particular processing feature will result in that processing feature being enabled for any software run by that conventional processing system (e.g., virtual machines provided by a hypervisor running on that conventional processing system). As such, when a particular processing system is used to provide multiple LCSs to different users that may each have different processing feature requirements, most of those LCSs will be provided processing features they do not need in their operations (e.g., more processor cores than are needed, processor accelerator functionality that is not needed, and/or other unneeded processing systems features that would be apparent to one of skill in the art in possession of the present disclosure).

Accordingly, it would be desirable to provide an LCS processing feature access control system that addresses the issues discussed above.

### SUMMARY

According to one embodiment, an Information Handling System (IHS) includes a resource management processing system; and a resource management memory system that is coupled to the resource management processing system and that includes instructions that, when executed by the resource management processing system, cause the resource management processing system to provide a resource management engine that is configured to: receive a first Logically Composed System (LCS) request to provide a first LCS; provide, in response to receiving the first LCS request, the first LCS using a first subset of a plurality of processing subsystems in a Central Processing Unit (CPU); receive a second LCS request to provide a second LCS; provide, in response to receiving the second LCS request, the second LCS using a second subset of the plurality of processing subsystems that is different than the first subset of the plurality of processing subsystems; receive a first LCS feature access request to provide access for the first LCS to a processing feature that is not available via the first subset of the plurality of processing subsystems; and provide, in response to receiving the first LCS feature access request, the first LCS using a third subset of the plurality of processing subsystems that is different than the first subset of the plurality of processing subsystems and that provides the processing feature.

### BRIEF DESCRIPTION OF THE DRAWINGS

FIG. 1 is a schematic view illustrating an embodiment of an Information Handling System (IHS).

FIG. 2 is a schematic view illustrating an embodiment of an LCS provisioning system.

FIG. 3 is a schematic view illustrating an embodiment of an LCS provisioning subsystem that may be included in the LCS provisioning system of FIG. 2.

FIG. 4 is a schematic view illustrating an embodiment of a resource system that may be included in the LCS provisioning subsystem of FIG. 3.

FIG. 5 is a schematic view illustrating an embodiment of the provisioning of an LCS using the LCS provisioning system of FIG. 2.

FIG. 6 is a schematic view illustrating an embodiment of the provisioning of an LCS using the LCS provisioning system of FIG. 2.

FIG. 7 is a schematic view illustrating an embodiment of an LCS processing feature access control system that may be provided according to the teaching of the present disclosure.

FIG. 8 is a schematic view illustrating an embodiment of a resource management system that may be included in the LCS processing feature access control system of FIG. 7.

FIG. 9 is a flow chart illustrating an embodiment of a method for controlling access to processing features for an LCS.

FIG. 10A is a schematic view illustrating an embodiment of the LCS processing feature access control system of FIG. 7 operating during the method of FIG. 9.

FIG. 10B is a schematic view illustrating an embodiment of the resource management system of FIG. 8 operating during the method of FIG. 9.

FIG. 11A is a schematic view illustrating an embodiment of the resource management system of FIG. 8 operating during the method of FIG. 9.

FIG. 11B is a schematic view illustrating an embodiment of a resource management system in the LCS processing feature access control system of FIG. 7 operating during the method of FIG. 9.

FIG. 12A is a schematic view illustrating an embodiment of the resource management system of FIG. 11B operating during the method of FIG. 9.

FIG. 12B is a schematic view illustrating an embodiment of the resource management system of FIG. 11B operating during the method of FIG. 9.

FIG. 12C is a schematic view illustrating an embodiment of the resource management system of FIG. 11B operating during the method of FIG. 9.

FIG. 13A is a schematic view illustrating an embodiment of the LCS processing feature access control system of FIG. 7 operating during the method of FIG. 9.

FIG. 13B is a schematic view illustrating an embodiment of the resource management system of FIG. 8 operating during the method of FIG. 9.

FIG. 14 is a schematic view illustrating an embodiment of the resource management system of FIG. 8 operating during the method of FIG. 9.

FIG. 15A is a schematic view illustrating an embodiment of the LCS processing feature access control system of FIG. 7 operating during the method of FIG. 9.

FIG. 15B is a schematic view illustrating an embodiment of the resource management system of FIG. 8 operating during the method of FIG. 9.

FIG. 16A is a schematic view illustrating an embodiment of the resource management system of FIG. 8 operating during the method of FIG. 9.

FIG. 16B is a schematic view illustrating an embodiment of the resource management system of FIG. 11B operating during the method of FIG. 9.

FIG. 17A is a schematic view illustrating an embodiment of the resource management system of FIG. 8 operating during the method of FIG. 9.

FIG. 17B is a schematic view illustrating an embodiment of the resource management system of FIG. 11B operating during the method of FIG. 9.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

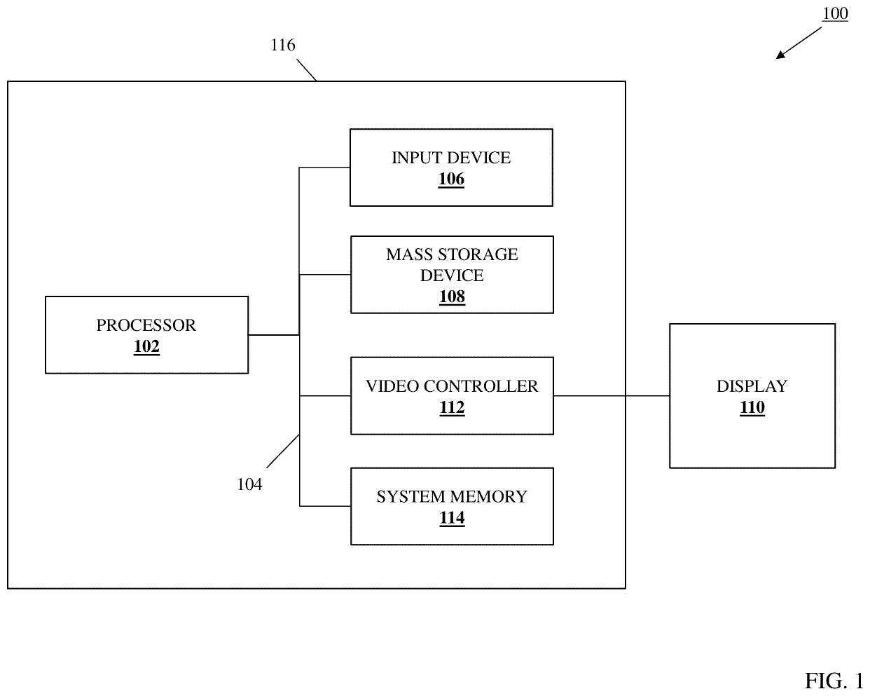

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

As discussed in further detail below, the LCS processing feature access control systems and methods of the present disclosure may be utilized with Logically Composed Systems (LCSs), which one of skill in the art in possession of the present disclosure will recognize may be provided to users as part of an intent-based, as-a-Service delivery platform that enables multi-cloud computing while keeping the corresponding infrastructure that is utilized to do so “invisible” to the user in order to, for example, simplify the user/workload performance experience. As such, the LCSs discussed herein enable relatively rapid utilization of technology from a relatively broader resource pool, optimize the allocation of resources to workloads to provide improved scalability and efficiency, enable seamless introduction of new technologies and value-add services, and/or provide a variety of other benefits that would be apparent to one of skill in the art in possession of the present disclosure.

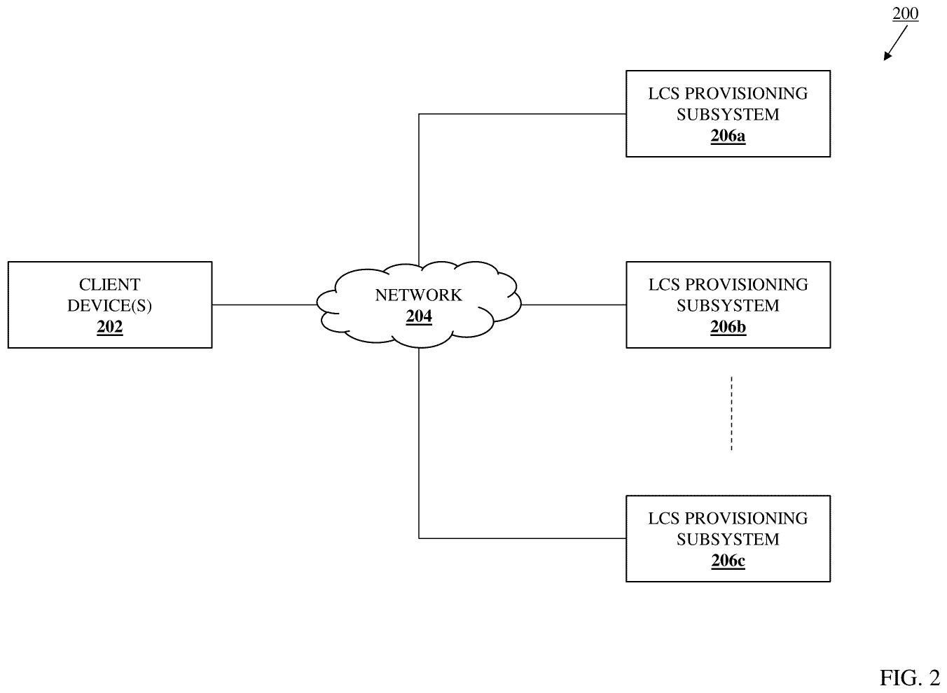

With reference to FIG. 2, an embodiment of a Logically Composed System (LCS) provisioning system 200 is illustrated that may be utilized with the LCS processing feature access control systems and methods of the present disclosure. In the illustrated embodiment, the LCS provisioning system 200 includes one or more client devices 202. In an embodiment, any or all of the client devices may be provided by the IHS 100 discussed above with reference to FIG. 1 and/or may include some or all of the components of the IHS 100, and in specific examples may be provided by desktop computing devices, laptop/notebook computing devices, tablet computing devices, mobile phones, and/or any other computing device known in the art. However, while illustrated and discussed as being provided by specific computing devices, one of skill in the art in possession of the present disclosure will recognize that the functionality of the client device(s) 202 discussed below may be provided by other computing devices that are configured to operate similarly as the client device(s) 202 discussed below, and that one of skill in the art in possession of the present disclosure would recognize as utilizing the LCSs described herein. As illustrated, the client device(s) 202 may be coupled to a network 204 that may be provided by a Local Area Network (LAN), the Internet, combinations thereof, and/or any of network that would be apparent to one of skill in the art in possession of the present disclosure.

As also illustrated in FIG. 2, a plurality of LCS provisioning subsystems 206a, 206b, and up to 206c are coupled to the network 204 such that any or all of those LCS provisioning subsystems 206a-206c may provide LCSs to the client device(s) 202 as discussed in further detail below. In an embodiment, any or all of the LCS provisioning subsystems 206a-206c may include one or more of the IHS 100 discussed above with reference to FIG. 1 and/or may include some or all of the components of the IHS 100. For example, in some of the specific examples provided below, each of the LCS provisioning subsystems 206a-206c may be provided by a respective datacenter or other computing device/computing component location (e.g., a respective one of the “clouds” that enables the “multi-cloud” computing discussed above) in which the components of that LCS provisioning subsystem are included. However, while a specific configuration of the LCS provisioning system 200 (e.g., including multiple LCS provisioning subsystems 206a-206c) is illustrated and described, one of skill in the art in possession of the present disclosure will recognize that other configurations of the LCS provisioning system 200 (e.g., a single LCS provisioning subsystem, LCS provisioning subsystems that span multiple datacenters/computing device/computing component locations, etc.) will fall within the scope of the present disclosure as well.

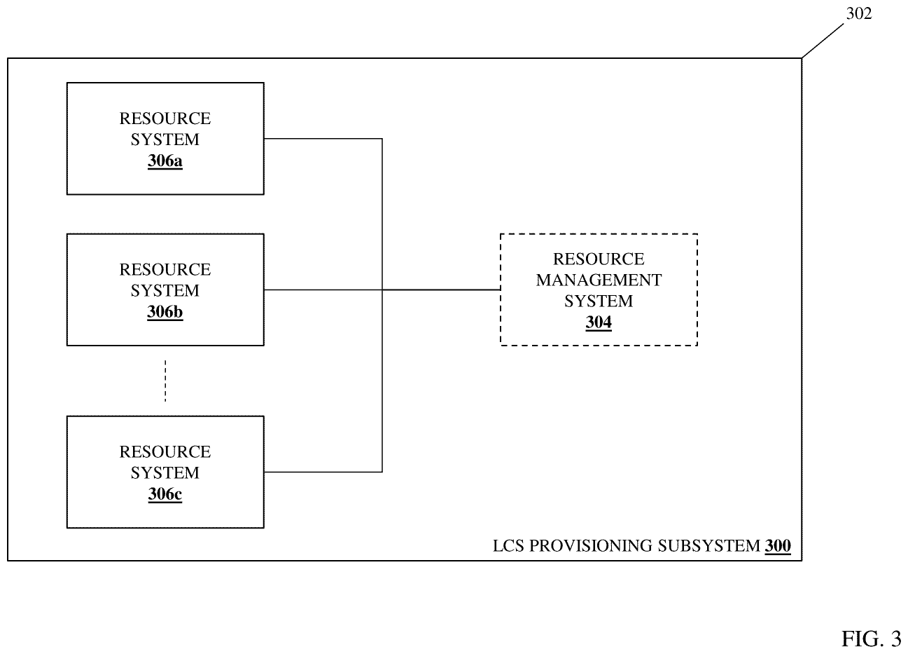

With reference to FIG. 3, an embodiment of an LCS provisioning subsystem 300 is illustrated that may provide any of the LCS provisioning subsystems 206a-206c discussed above with reference to FIG. 2. As such, the LCS provisioning subsystem 300 may include one or more of the IHS 100 discussed above with reference to FIG. 1 and/or may include some or all of the components of the IHS 100, and in the specific examples provided below may be provided by a datacenter or other computing device/computing component location in which the components of the LCS provisioning subsystem 300 are included. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

In the illustrated embodiment, the LCS provisioning subsystem 300 is provided in a datacenter 302, and includes a resource management system 304 coupled to a plurality of resource systems 306a, 306b, and up to 306c. In an embodiment, any of the resource management system 304 and the resource systems 306a-306c may be provided by the IHS 100 discussed above with reference to FIG. 1 and/or may include some or all of the components of the IHS 100. In the specific embodiments provided below, each of the resource management system 304 and the resource systems 306a-306c may include a System Control Processor (SCP) device that may be conceptualized as an “enhanced” SmartNIC device that may be configured to perform functionality that is not available in conventional SmartNIC devices such as, for example, the resource management functionality, LCS provisioning functionality, and/or other SCP functionality described herein.

In an embodiment, any of the resource systems 306a-306c may include any of the resources described below coupled to an SCP device that is configured to facilitate management of those resources by the resource management system 304. Furthermore, the SCP device included in the resource management system 304 may provide an SCP Manager (SCPM) subsystem that is configured to manage the SCP devices in the resource systems 306a-306c, and that performs the functionality of the resource management system 304 described below. In some examples, the resource management system 304 may be provided by a “stand-alone” system (e.g., that is provided in a separate chassis from each of the resource systems 306a-306c), and the SCPM subsystem discussed below may be provided by a dedicated SCP device, processing/memory resources, and/or other components in that resource management system 304. However, in other embodiments, the resource management system 304 may be provided by one of the resource systems 306a-306c (e.g., it may be provided in a chassis of one of the resource systems 306a-306c), and the SCPM subsystem may be provided by an SCP device, processing/memory resources, and/or any other any other components om that resource system.

As such, the resource management system 304 is illustrated with dashed lines in FIG. 3 to indicate that it may be a stand-alone system in some embodiments, or may be provided by one of the resource systems 306a-306c in other embodiments. Furthermore, one of skill in the art in possession of the present disclosure will appreciate how SCP devices in the resource systems 306a-306c may operate to “elect” or otherwise select one or more of those SCP devices to operate as the SCPM subsystem that provides the resource management system 304 described below. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

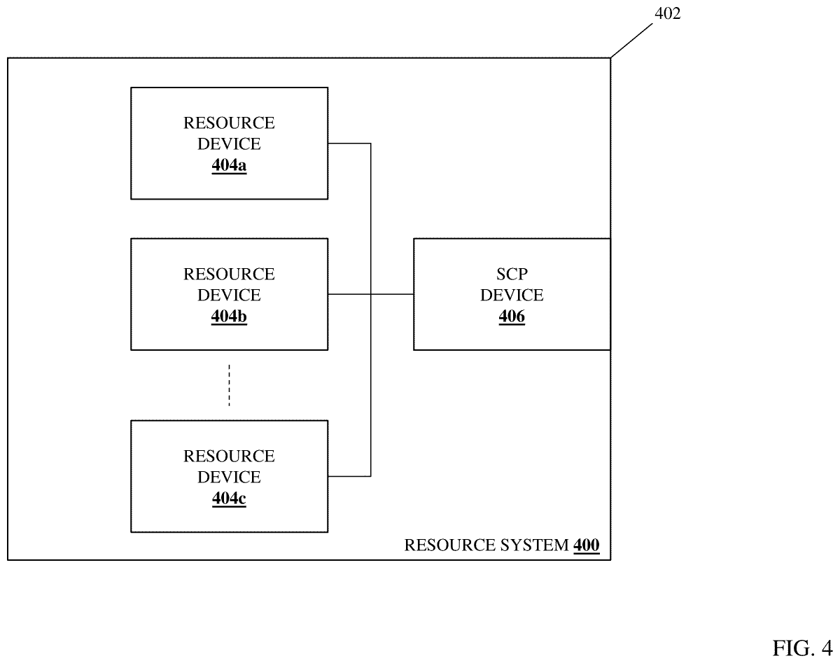

With reference to FIG. 4, an embodiment of a resource system 400 is illustrated that may provide any or all of the resource systems 306a-306c discussed above with reference to FIG. 3. In an embodiment, the resource system 400 may be provided by the IHS 100 discussed above with reference to FIG. 1 and/or may include some or all of the components of the IHS 100. In the illustrated embodiment, the resource system 400 includes a chassis 402 that houses the components of the resource system 400, only some of which are illustrated and discussed below. In the illustrated embodiment, the chassis 402 houses an SCP device 406. In an embodiment, the SCP device 406 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an SCP engine that is configured to perform the functionality of the SCP engines and/or SCP devices discussed below. Furthermore, the SCP device 406 may also include any of a variety of SCP components (e.g., hardware/software) that are configured to enable any of the SCP functionality described below.

In the illustrated embodiment, the chassis 402 also houses a plurality of resource devices 404a, 404b, and up to 404c, each of which is coupled to the SCP device 406. For example, the resource devices 404a-404c may include processing systems (e.g., first type processing systems such as those available from INTEL® Corporation of Santa Clara, California, United States, second type processing systems such as those available from ADVANCED MICRO DEVICES (AMD)@Inc. of Santa Clara, California, United States, Advanced Reduced Instruction Set Computer (RISC) Machine (ARM) devices, Graphics Processing Unit (GPU) devices, Tensor Processing Unit (TPU) devices, Field Programmable Gate Array (FPGA) devices, accelerator devices, etc.); memory systems (e.g., Persistence MEMory (PMEM) devices (e.g., solid state byte-addressable memory devices that reside on a memory bus), etc.); storage devices (e.g., Non-Volatile Memory express over Fabric (NVMe-oF) storage devices, Just a Bunch Of Flash (JBOF) devices, etc.); networking devices (e.g., Network Interface Controller (NIC) devices, etc.); and/or any other devices that one of skill in the art in possession of the present disclosure would recognize as enabling the functionality described as being enabled by the resource devices 404a-404c discussed below. As such, the resource devices 404a-404c in the resource systems 306a-306c/400 may be considered a “pool” of resources that are available to the resource management system 304 for use in composing LCSs.

To provide a specific example, the SCP devices described herein may operate to provide a Root-of-Trust (RoT) for their corresponding resource devices/systems, to provide an intent management engine for managing the workload intents discussed below, to perform telemetry generation and/or reporting operations for their corresponding resource devices/systems, to perform identity operations for their corresponding resource devices/systems, provide an image boot engine (e.g., an operating system image boot engine) for LCSs composed using a processing system/memory system controlled by that SCP device, and/or perform any other operations that one of skill in the art in possession of the present disclosure would recognize as providing the functionality described below. Further, as discussed below, the SCP devices describe herein may include Software-Defined Storage (SDS) subsystems, inference subsystems, data protection subsystems, Software-Defined Networking (SDN) subsystems, trust subsystems, data management subsystems, compression subsystems, encryption subsystems, and/or any other hardware/software described herein that may be allocated to an LCS that is composed using the resource devices/systems controlled by that SCP device. However, while an SCP device is illustrated and described as performing the functionality discussed below, one of skill in the art in possession of the present disclosure will appreciated that functionality described herein may be enabled on other devices while remaining within the scope of the present disclosure as well.

Thus, the resource system 400 may include the chassis 402 including the SCP device 406 connected to any combinations of resource devices. To provide a specific embodiment, the resource system 400 may provide a “Bare Metal Server” that one of skill in the art in possession of the present disclosure will recognize may be a physical server system that provides dedicated server hosting to a single tenant, and thus may include the chassis 402 housing a processing system and a memory system, the SCP device 406, as well as any other resource devices that would be apparent to one of skill in the art in possession of the present disclosure. However, in other specific embodiments, the resource system 400 may include the chassis 402 housing the SCP device 406 coupled to particular resource devices 404a-404c. For example, the chassis 402 of the resource system 400 may house a plurality of processing systems (i.e., the resource devices 404a-404c) coupled to the SCP device 406. In another example, the chassis 402 of the resource system 400 may house a plurality of memory systems (i.e., the resource devices 404a-404c) coupled to the SCP device 406. In another example, the chassis 402 of the resource system 400 may house a plurality of storage devices (i.e., the resource devices 404a-404c) coupled to the SCP device 406. In another example, the chassis 402 of the resource system 400 may house a plurality of networking devices (i.e., the resource devices 404a-404c) coupled to the SCP device 406. However, one of skill in the art in possession of the present disclosure will appreciate that the chassis 402 of the resource system 400 housing a combination of any of the resource devices discussed above will fall within the scope of the present disclosure as well.

As discussed in further detail below, the SCP device 406 in the resource system 400 will operate with the resource management system 304 (e.g., an SCPM subsystem) to allocate any of its resources devices 404a-404c for use in a providing an LCS. Furthermore, the SCP device 406 in the resource system 400 may also operate to allocate SCP hardware and/or perform functionality, which may not be available in a resource device that it has allocated for use in providing an LCS, in order to provide any of a variety of functionality for the LCS. For example, the SCP engine and/or other hardware/software in the SCP device 406 may be configured to perform encryption functionality, compression functionality, and/or other storage functionality known in the art, and thus if that SCP device 406 allocates storage device(s) (which may be included in the resource devices it controls) for use in a providing an LCS, that SCP device 406 may also utilize its own SCP hardware and/or software to perform that encryption functionality, compression functionality, and/or other storage functionality as needed for the LCS as well. However, while particular SCP-enabled storage functionality is described herein, one of skill in the art in possession of the present disclosure will appreciate how the SCP devices 406 described herein may allocate SCP hardware and/or perform other enhanced functionality for an LCS provided via allocation of its resource devices 404a-404c while remaining within the scope of the present disclosure as well.

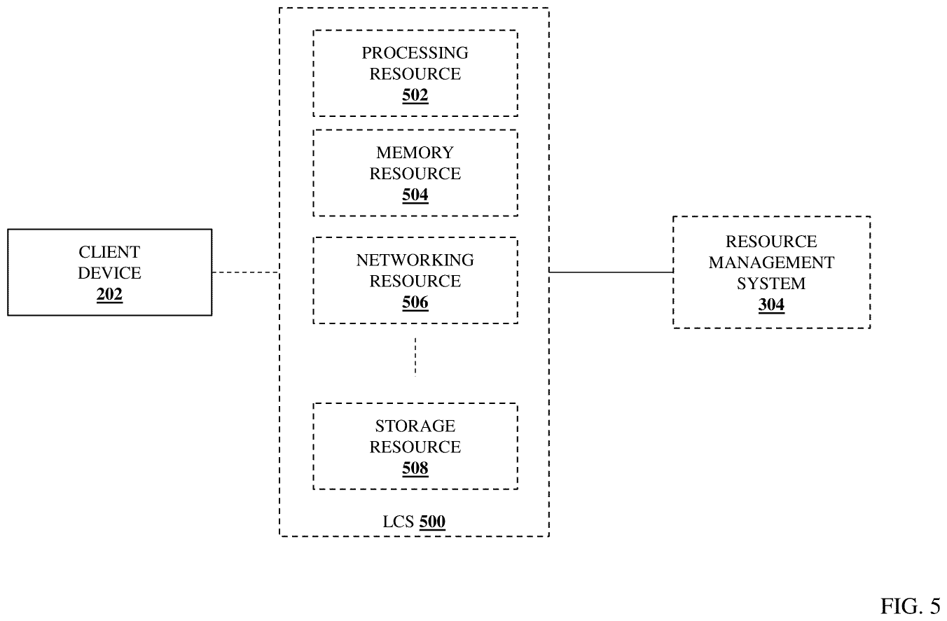

With reference to FIG. 5, an example of the provisioning of an LCS 500 to one of the client device(s) 202 is illustrated. For example, the LCS provisioning system 200 may allow a user of the client device 202 to express a “workload intent” that describes the general requirements of a workload that user would like to perform (e.g., “I need an LCS with 10 gigahertz (Ghz) of processing power and 8 gigabytes (GB) of memory capacity for an application requiring 20 terabytes (TB) of high-performance protected-object-storage for use with a hospital-compliant network”, or “I need an LCS for a machine-learning environment requiring Tensorflow processing with 3 TBs of Accelerator PMEM memory capacity”). As will be appreciated by one of skill in the art in possession of the present disclosure, the workload intent discussed above may be provided to one of the LCS provisioning subsystems 206a-206c, and may be satisfied using resource systems that are included within that LCS provisioning subsystem, or satisfied using resource systems that are included across the different LCS provisioning subsystems 206a-206c.

As such, the resource management system 304 in the LCS provisioning subsystem that received the workload intent may operate to compose the LCS 500 using resource devices 404a-404c in the resource systems 306a-306c/400 in that LCS provisioning subsystem, and/or resource devices 404a-404c in the resource systems 306a-306c/400 in any of the other LCS provisioning subsystems. FIG. 5 illustrates the LCS 500 including a processing resource 502 allocated from one or more processing systems provided by one or more of the resource devices 404a-404c in one or more of the resource systems 306a-306c/400 in one or more of the LCS provisioning subsystems 206a-206c, a memory resource 504 allocated from one or more memory systems provided by one or more of the resource devices 404a-404c in one or more of the resource systems 306a-306c/400 in one or more of the LCS provisioning subsystems 206a-206c, a networking resource 506 allocated from one or more networking devices provided by one or more of the resource devices 404a-404c in one or more of the resource systems 306a-306c/400 in one or more of the LCS provisioning subsystems 206a-206c, and/or a storage resource 508 allocated from one or more storage devices provided by one or more of the resource devices 404a-404c in one or more of the resource systems 306a-306c/400 in one or more of the LCS provisioning subsystems 206a-206c.

Furthermore, as will be appreciated by one of skill in the art in possession of the present disclosure, any of the processing resource 502, memory resource 504, networking resource 506, and the storage resource 508 may be provided from a portion of a processing system (e.g., a core in a processor, a time-slice of processing cycles of a processor, etc.), a portion of a memory system (e.g., a subset of memory capacity in a memory device), a portion of a storage device (e.g., a subset of storage capacity in a storage device), and/or a portion of a networking device (e.g., a portion of the bandwidth of a networking device). Further still, as discussed above, the SCP device(s) 406 in the resource systems 306a-306c/400 that allocate any of the resource devices 404a-404c that provide the processing resource 502, memory resource 504, networking resource 506, and the storage resource 508 in the LCS 500 may also allocate their SCP hardware and/or perform enhanced functionality (e.g., the enhanced storage functionality in the specific examples provided above) for any of those resources that may otherwise not be available in the processing system, memory system, storage device, or networking device allocated to provide those resources in the LCS 500.

With the LCS 500 composed using the processing resources 502, the memory resources 504, the networking resources 506, and the storage resources 508, the resource management system 304 may provide the client device 202 resource communication information such as, for example, Internet Protocol (IP) addresses of each of the systems/devices that provide the resources that make up the LCS 500, in order to allow the client device 202 to communicate with those systems/devices in order to utilize the resources that make up the LCS 500. As will be appreciated by one of skill in the art in possession of the present disclosure, the resource communication information may include any information that allows the client device 202 to present the LCS 500 to a user in a manner that makes the LCS 500 appear the same as an integrated physical system having the same resources as the LCS 500.

Thus, continuing with the specific example above in which the user provided the workload intent defining an LCS with a 10 Ghz of processing power and 8 GB of memory capacity for an application with 20 TB of high-performance protected object storage for use with a hospital-compliant network, the processing resources 502 in the LCS 500 may be configured to utilize 10 Ghz of processing power from processing systems provided by resource device(s) in the resource system(s), the memory resources 504 in the LCS 500 may be configured to utilize 8 GB of memory capacity from memory systems provided by resource device(s) in the resource system(s), the storage resources 508 in the LCS 500 may be configured to utilize 20 TB of storage capacity from high-performance protected-object-storage storage device(s) provided by resource device(s) in the resource system(s), and the networking resources 506 in the LCS 500 may be configured to utilize hospital-compliant networking device(s) provided by resource device(s) in the resource system(s).

Similarly, continuing with the specific example above in which the user provided the workload intent defining an LCS for a machine-learning environment for Tensorflow processing with 3 TBs of Accelerator PMEM memory capacity, the processing resources 502 in the LCS 500 may be configured to utilize TPU processing systems provided by resource device(s) in the resource system(s), and the memory resources 504 in the LCS 500 may be configured to utilize 3 TB of accelerator PMEM memory capacity from processing systems/memory systems provided by resource device(s) in the resource system(s), while any networking/storage functionality may be provided for the networking resources 506 and storage resources 508, if needed.

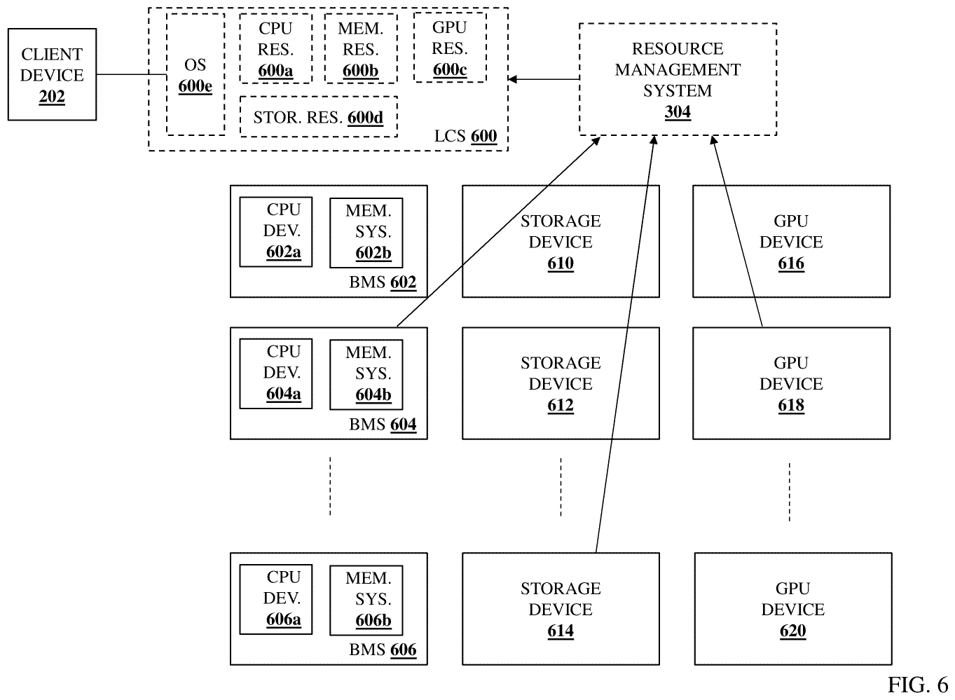

With reference to FIG. 6, another example of the provisioning of an LCS 600 to one of the client device(s) 202 is illustrated. As will be appreciated by one of skill in the art in possession of the present disclosure, many of the LCSs provided by the LCS provisioning system 200 will utilize a “compute” resource (e.g., provided by a processing resource such as an x86 processor, an AMD processor, an ARM processor, and/or other processing systems known in the art, along with a memory system that includes instructions that, when executed by the processing system, cause the processing system to perform any of a variety of compute operations known in the art), and in many situations those compute resources may be allocated from a Bare Metal Server (BMS) and presented to a client device 202 user along with storage resources, networking resources, other processing resources (e.g., GPU resources), and/or any other resources that would be apparent to one of skill in the art in possession of the present disclosure.

As such, in the illustrated embodiment, the resource systems 306a-306c available to the resource management system 304 include a Bare Metal Server (BMS) 602 having a Central Processing Unit (CPU) device 602a and a memory system 602b, a BMS 604 having a CPU device 604a and a memory system 604b, and up to a BMS 606 having a CPU device 606a and a memory system 606b. Furthermore, one or more of the resource systems 306a-306c includes resource devices 404a-404c provided by a storage device 610, a storage device 612, and up to a storage device 614. Further still, one or more of the resource systems 306a-306c includes resource devices 404a-404c provided by a Graphics Processing Unit (GPU) device 616, a GPU device 618, and up to a GPU device 620.

FIG. 6 illustrates how the resource management system 304 may compose the LCS 600 using the BMS 604 to provide the LCS 600 with CPU resources 600a that utilize the CPU device 604a in the BMS 604, and memory resources 600b that utilize the memory system 604b in the BMS 604. Furthermore, the resource management system 304 may compose the LCS 600 using the storage device 614 to provide the LCS 600 with storage resources 600d, and using the GPU device 318 to provide the LCS 600 with GPU resources 600c. As illustrated in the specific example in FIG. 6, the CPU device 604a and the memory system 604b in the BMS 604 may be configured to provide an operating system 600e that is presented to the client device 202 as being provided by the CPU resources 600a and the memory resources 600b in the LCS 600, with operating system 600e utilizing the GPU device 618 to provide the GPU resources 600c in the LCS 600, and utilizing the storage device 614 to provide the storage resources 600d in the LCS 600. The user of the client device 202 may then provide any application(s) on the operating system 600e provided by the CPU resources 600a/CPU device 604a and the memory resources 600b/memory system 604b in the LCS 600/BMS 604, with the application(s) operating using the CPU resources 600a/CPU device 604a, the memory resources 600b/memory system 604b, the GPU resources 600c/GPU device 618, and the storage resources 600d/storage device 614.

Furthermore, as discussed above, the SCP device(s) 406 in the resource systems 306a-306c/400 that allocates any of the CPU device 604a and memory system 604b in the BMS 604 that provide the CPU resource 600a and memory resource 600b, the GPU device 618 that provides the GPU resource 600c, and the storage device 614 that provides storage resource 600d, may also allocate SCP hardware and/or perform enhanced functionality (e.g., the enhanced storage functionality in the specific examples provided above) for any of those resources that may otherwise not be available in the CPU device 604a, memory system 604b, storage device 614, or GPU device 618 allocated to provide those resources in the LCS 500.

However, while simplified examples are described above, one of skill in the art in possession of the present disclosure will appreciate how multiple devices/systems (e.g., multiple CPUs, memory systems, storage devices, and/or GPU devices) may be utilized to provide an LCS. Furthermore, any of the resources utilized to provide an LCS (e.g., the CPU resources, memory resources, storage resources, and/or GPU resources discussed above) need not be restricted to the same device/system, and instead may be provided by different devices/systems over time (e.g., the GPU resources 600c may be provided by the GPU device 618 during a first time period, by the GPU device 616 during a second time period, and so on) while remaining within the scope of the present disclosure as well. Further still, while the discussions above imply the allocation of physical hardware to provide LCSs, one of skill in the art in possession of the present disclosure will recognize that the LCSs described herein may be composed similarly as discussed herein from virtual resources. For example, the resource management system 304 may be configured to allocate a portion of a logical volume provided in a Redundant Array of Independent Disk (RAID) system to an LCS, allocate a portion/time-slice of GPU processing performed by a GPU device to an LCS, and/or perform any other virtual resource allocation that would be apparent to one of skill in the art in possession of the present disclosure in order to compose an LCS.

Similarly as discussed above, with the LCS 600 composed using the CPU resources 600a, the memory resources 600b, the GPU resources 600c, and the storage resources 600d, the resource management system 304 may provide the client device 202 resource communication information such as, for example, Internet Protocol (IP) addresses of each of the systems/devices that provide the resources that make up the LCS 600, in order to allow the client device 202 to communicate with those systems/devices in order to utilize the resources that make up the LCS 600. As will be appreciated by one of skill in the art in possession of the present disclosure, the resource communication information allows the client device 202 to present the LCS 600 to a user in a manner that makes the LCS 600 appear the same as an integrated physical system having the same resources as the LCS 600.

As will be appreciated by one of skill in the art in possession of the present disclosure, the LCS provisioning system 200 discussed above solves issues present in conventional Information Technology (IT) infrastructure systems that utilize “purpose-built” devices (server devices, storage devices, etc.) in the performance of workloads and that often result in resources in those devices being underutilized. This is accomplished, at least in part, by having the resource management system(s) 304 “build” LCSs that satisfy the needs of workloads when they are deployed. As such, a user of a workload need simply define the needs of that workload via a “manifest” expressing the workload intent of the workload, and resource management system 304 may then compose an LCS by allocating resources that define that LCS and that satisfy the requirements expressed in its workload intent, and present that LCS to the user such that the user interacts with those resources in same manner as they would physical system at their location having those same resources.

However, as discussed above, the provisioning of LCSs using components like the processing systems in server devices and/or BMSs as described above presents issues with regard to the utilization of processing system service features like Si-aaS, as the conventional enablement of any particular processing feature in a conventional processing system will result in that processing feature being enabled for any software run by that processing system (e.g., virtual machines provided by a hypervisor running on that processing system), and typically results in most LCSs being provided processing features they do not need in their operations when the same processing system is used to provide those LCSs to different users that each have different processing feature requirements.

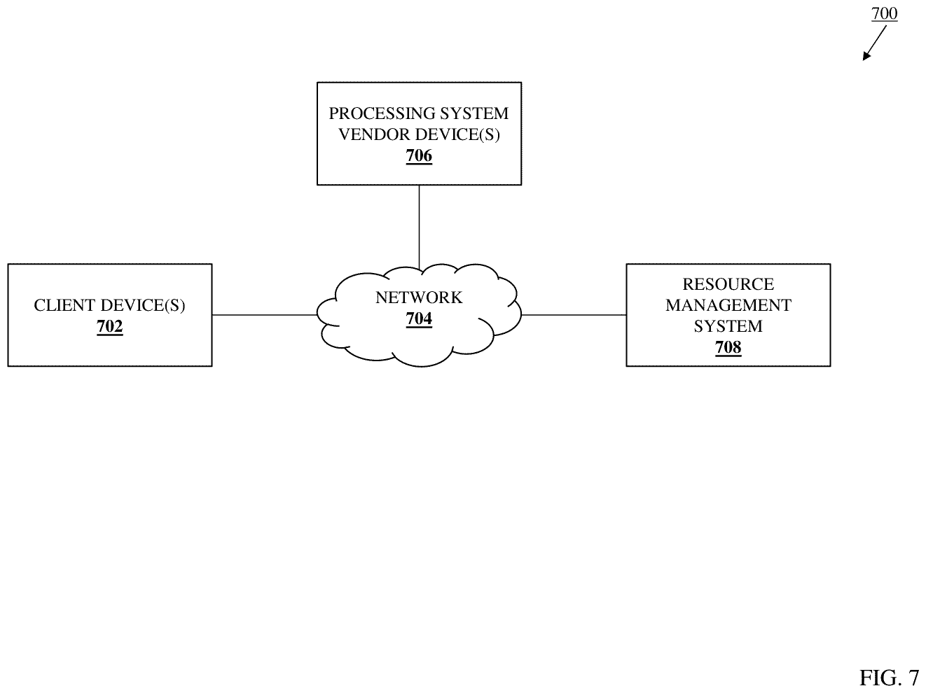

Referring now to FIG. 7, an embodiment of an LCS processing feature access control system 700 is illustrated that addresses the issues discussed above when utilizing processing system service features like Si-aaS when providing LCSs. In the illustrated embodiment, the LCS processing feature access control system 700 includes one or more client devices 702, any of which may be provided by the client devices 202 discussed above. As such, the client device(s) 702 may be provided by the IHS 100 discussed above with reference to FIG. 1, and/or may include some or all of the components of the IHS 100, and in specific examples may be provided desktop computing devices, laptop/notebook computing devices, tablet computing devices, mobile phones, and/or any other computing device known in the art. However, while illustrated and discussed as being provided by particular client devices, one of skill in the art in possession of the present disclosure will recognize that client device(s) 702 provided in the LCS processing feature access control system 700 may include any devices that may be configured to operate similarly as the client device(s) 702 discussed below.

As illustrated, the client device(s) 702 may be coupled to a network 704 that may be similar to the network 204 discussed above with reference to FIG. 2, and thus may be provided by a LAN, the Internet, combinations thereof, and/or any of network that would be apparent to one of skill in the art in possession of the present disclosure. In the illustrated embodiment, one or more processing system vendor devices 706 are coupled to the network 704. In an embodiment, the processing system vendor device(s) 706 may be provided by the IHS 100 discussed above with reference to FIG. 1, and/or may include some or all of the components of the IHS 100, and in specific examples may be provided by server device(s) controlled by processing system vendor(s) that provide the processing systems described below. However, while illustrated and discussed as being provided by particular processing system vendor device(s), one of skill in the art in possession of the present disclosure will recognize that processing system vendor devices provided in the LCS processing feature access control system 700 may include any devices that may be configured to operate similarly as the processing system vendor device(s) 706 discussed below.

In the illustrated embodiment, a resource management system 708 is coupled to the network 704, and may be provided by the resource management system 304 discussed above. As such, the resource management system 708 may be provided by the SCP Manager (SCPM) subsystem discussed above, and in specific examples may be provided by a microvisor running on the SCP device that provides that SCPM subsystem as described above. However, while illustrated and discussed as being provided by particular subsystems such as a microvisor on an SCPM, one of skill in the art in possession of the present disclosure will recognize that resource management systems provided in the LCS processing feature access control system 700 may include any devices that may be configured to operate similarly as the resource management system 708 discussed below. Furthermore, while a specific LCS processing feature access control system 700 has been illustrated and described, one of skill in the art in possession of the present disclosure will recognize that the LCS processing feature access control system of the present disclosure may include a variety of components and component configurations while remaining within the scope of the present disclosure as well.

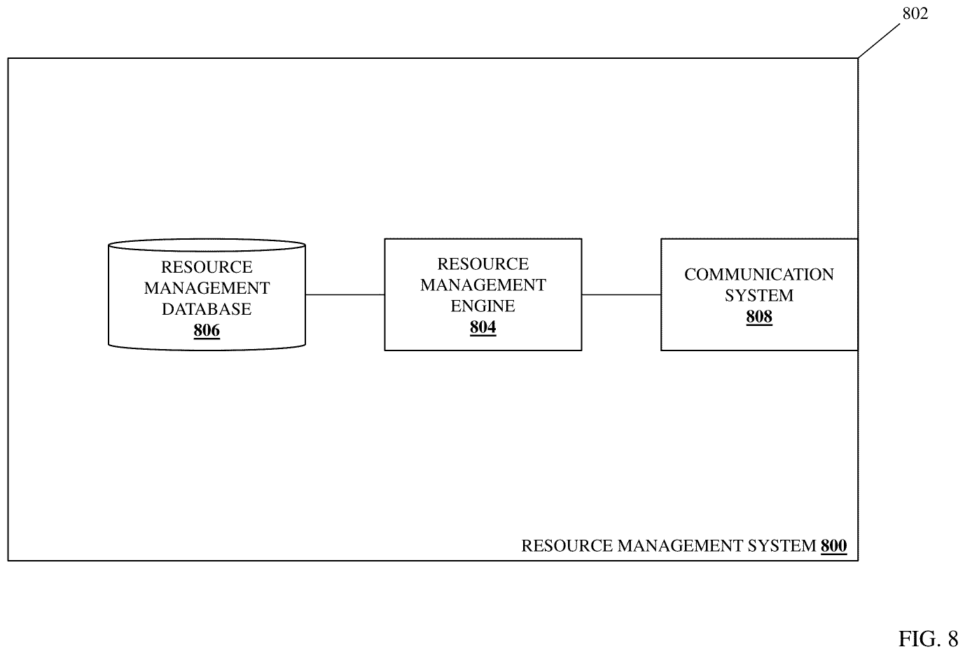

Referring now to FIG. 8, an embodiment of a resource management system 800 is illustrated that may provide the resource management system 708 discussed above with reference to FIG. 7. As such, the resource management system 800 may be provided by the IHS 100 discussed above with reference to FIG. 1 and/or may include some or all of the components of the IHS 100, and in specific examples may be provided by a microvisor running on an SCP device that provides an SCPM subsystem. However, while illustrated and discussed as being provided by particular resource management subsystems, one of skill in the art in possession of the present disclosure will recognize that the functionality of the resource management system 800 discussed below may be provided by other devices that are configured to operate similarly as the resource management system 800 discussed below.

In the illustrated embodiment, the resource management system 800 includes a chassis 802 that houses the components of the resource management system 800, only some of which are illustrated and described below. For example, the chassis 802 may house a resource management processing system (not illustrated, but which may include the processor 102 discussed above with reference to FIG. 1) and a resource management memory system (not illustrated, but which may include the memory 114 discussed above with reference to FIG. 1) that is coupled to the resource management processing system and that includes instructions that, when executed by the resource management processing system, cause the resource management processing system to provide a resource management engine 804 that is configured to perform the functionality of the resource management engines, resource management subsystem, and/or resource management systems discussed below.

The chassis 802 may also house a storage system (not illustrated, but which may include the storage 108 discussed above with reference to FIG. 1) that is coupled to the resource management engine 804 (e.g., via a coupling between the storage system and the resource management processing system) and that includes a resource management database 806 that is configured to store any of the information utilized by the resource management engine 804 discussed below. The chassis 802 may also house a communication system 808 that is coupled to the resource management engine 804 (e.g., via a coupling between the communication system 308 and the resource management processing system) and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure. However, while a specific resource management system 800 has been illustrated and described, one of skill in the art in possession of the present disclosure will recognize that resource management systems (or other devices operating according to the teachings of the present disclosure in a manner similar to that described below for the resource management system 800) may include a variety of components and/or component configurations for providing conventional resource management functionality, as well as the LCS processing feature access control functionality discussed below, while remaining within the scope of the present disclosure as well.

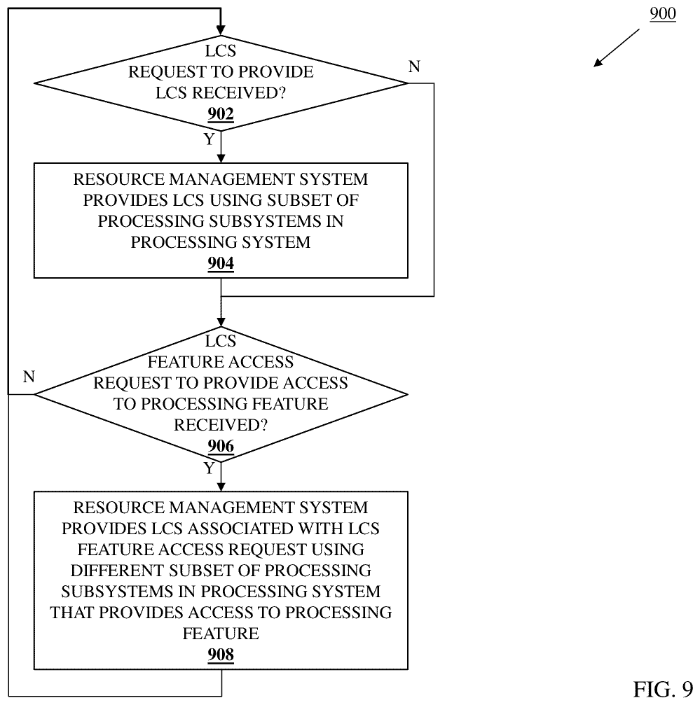

Referring now to FIG. 9, an embodiment of a method 900 for controlling access to processing features for a Logically Composed System (LCS) is illustrated. As discussed below, the systems and methods of the present disclosure provide for the provisioning of multiple LCSs using different processing subsystems in a processing system, as well as the enablement of processing features for any of those LCSs “on-demand” via modification of the subset of processing subsystems in the processing system used to provide that LCS. For example, the LCS processing feature access control system of the present disclosure may include a resource management system coupled to a processing system including a plurality of processing subsystems. The resource management system receives a first LCS request to provide a first LCS, and provides the first LCS using a first subset of the processing subsystems. The resource management system also receives a second LCS request to provide a second LCS, and provides the second LCS using a second subset of the processing subsystems that is different than the first subset of the processing subsystems, The resource management system then receives a first LCS feature access request to provide access for the first LCS to a processing feature that is not available via the first subset of the processing subsystems, and provides the first LCS using a third subset of the processing subsystems that is different than the first subset and that provides the processing feature. As such, processing system service features like Si-aaS may be utilized for processing system that provide multiple LCSs, allowing users to be provided (and only charged for) processing features required to provide their LCSs.

The method 900 begins at decision block 902 where the method 900 proceeds depending on whether an LCS request to provide an LCS is received. Similarly as described above, in an embodiment of block 902, the resource management system 708 may monitor for LCS requests (e.g., the “workload intent” discussed above that describes the general requirements of a workload that a user would like to perform) from the client device(s) 702 via the network 704.

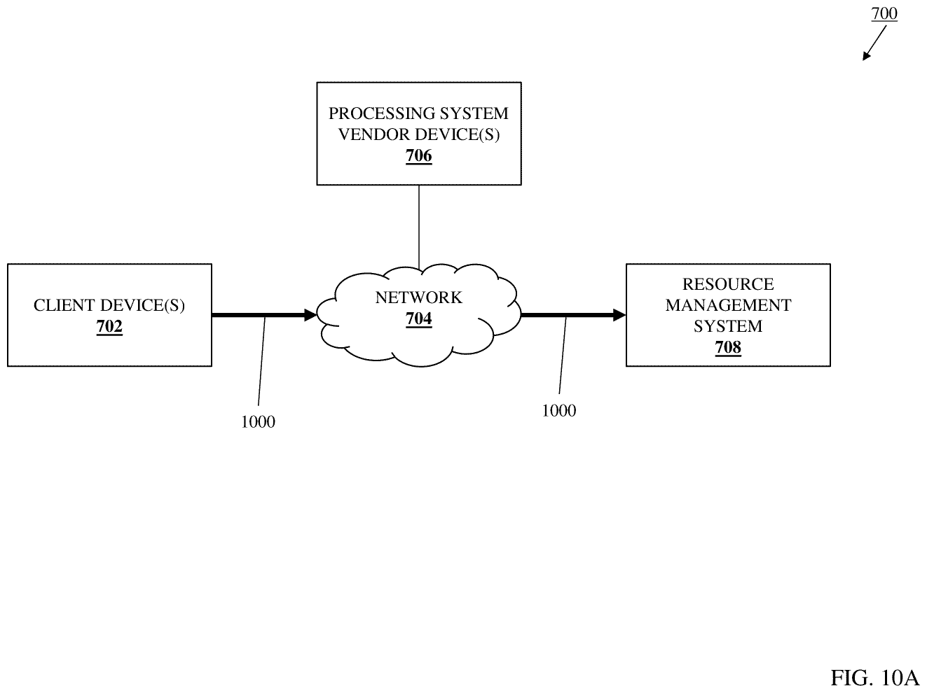

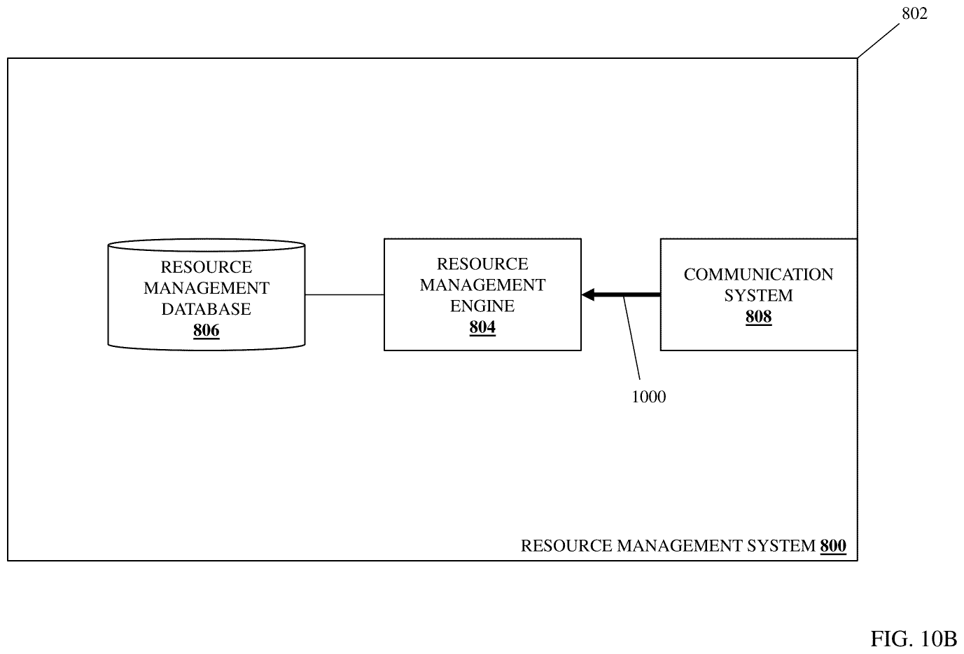

If, at decision block 902, an LCS request is received, the method 900 proceeds to block 904 where a resource management system provides an LCS using a subset of processing subsystems in a processing system. With reference to FIGS. 10A and 10B, in an embodiment of decision block 902, any of the client device(s) 702 may perform LCS request operations 1000 that include generating and transmitting an LCS request (e.g., the “workload intent” discussed above that describes the general requirements of a workload that a user of that client device would like to perform) via the network 704 and to the resource management system 708/800 such that the resource management engine 804 receives that LCS request via its communication system 808. In an embodiment, at block 904 and in response to receiving the LCS request at decision block 902, the resource management system 708 may perform any of the LCS provisioning operations discussed above in order to provide an LCS that satisfies that LCS request using any resource systems/resource devices that are accessible to the resource management system 708.

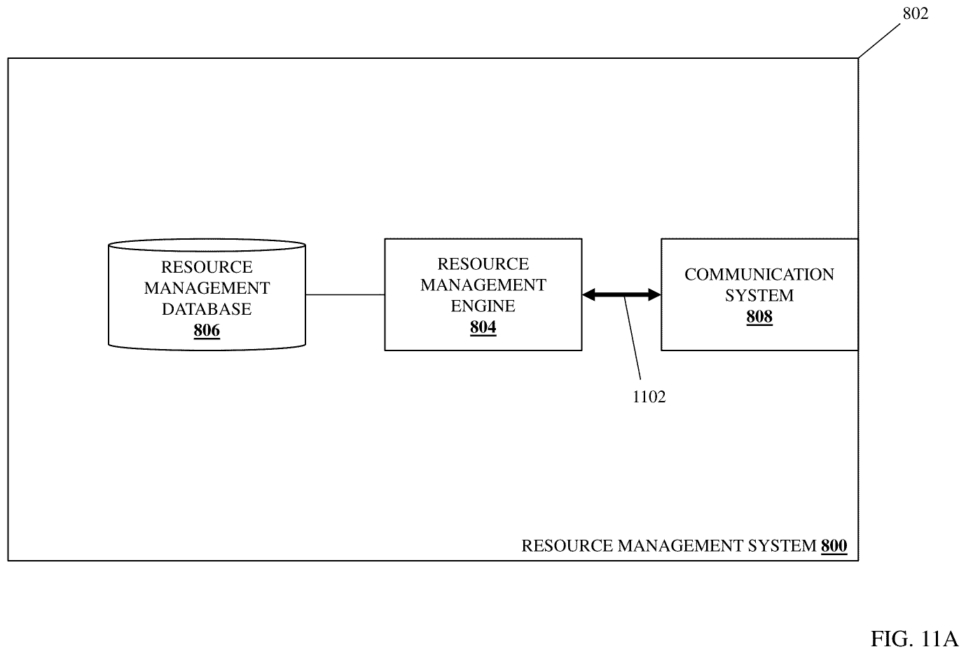

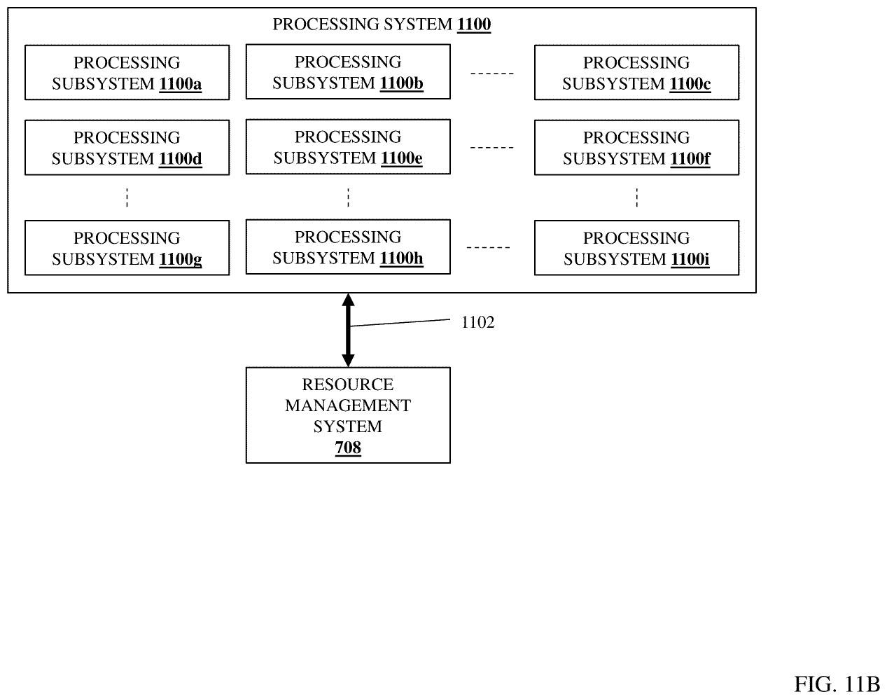

With reference to FIGS. 11A and 11B, a specific example of block 904 illustrates a processing system 1100 that is accessible to the resource management system 708 and that may be may be configured to provide the LCS for which the LCS request was received at decision block 902. In the illustrated examples, the processing system 1100 includes a plurality of processing subsystems 1100a, 1100b, and up to 1100c; a plurality of processing subsystems 1100d, 1100e, and up to 1100f; and up to a plurality of processing subsystems 1100g, 1100h, and up to 1100i. In the specific examples provided below, the processing system 1100 is described as being provided by a Central Processing Unit (CPU), with the processing subsystems 1100a, 1100d, and 1100g provided by processor cores in the CPU, the processing subsystems 1100b, 1100e, and 1100h provided by processor accelerators for the processing subsystems 1100a, 1100d, and 1100g, respectively; and the processing subsystems 1100c, 1100f, and 1100i providing any other processing features for the processing subsystems 1100a, 1100d, and 1100g, respectively, that would be apparent to one of skill in the art in possession of the present disclosure.

However, while a specific processing system 1100 with specific processing subsystems is illustrated and described, one of skill in the art in possession of the present disclosure will appreciate how a variety of processing systems/processing subsystems will fall within the scope of the present disclosure as well. For example, while the processing system 1100 is described as a physical CPU (e.g., a CPU included in a BMS as described above), one of skill in the art in possession of the present disclosure will appreciate how the processing system 1100 may be provided by a virtual CPU or other virtual processing systems while remaining within the scope of the present disclosure.

As such, at block 904, the resource management engine 804 in the resource management system 708/800 may perform processing system configuration operations 1102 via its communication system 808 and with the processing system 1100 that may include configuring a subset of the processing subsystems 1100a-1100i in the processing system 1100 to provide an LCS as part of the LCS provisioning operations described below. Furthermore, as will be appreciated by one of skill in the art in possession of the present disclosure, the processing system configuration operations 1102 may be accompanied by any of the other resource device configuration operations described above in order to provide an LCS as part of the LCS provisioning operations described below.

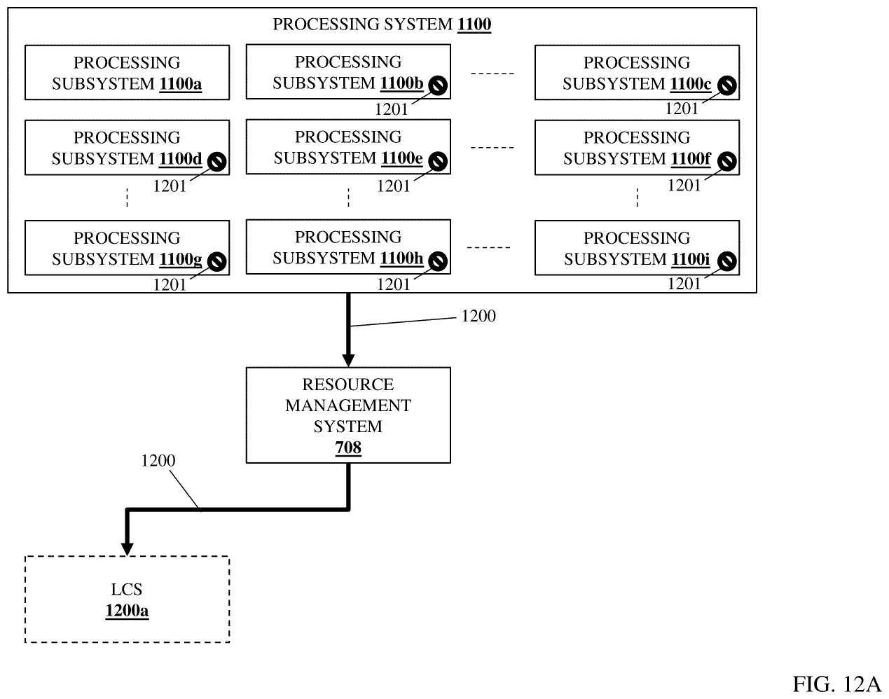

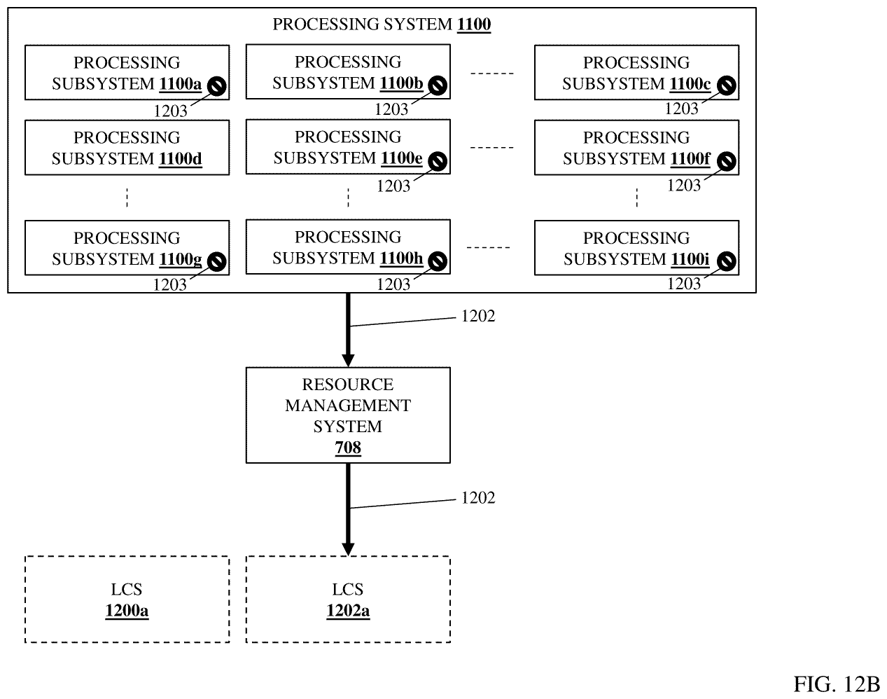

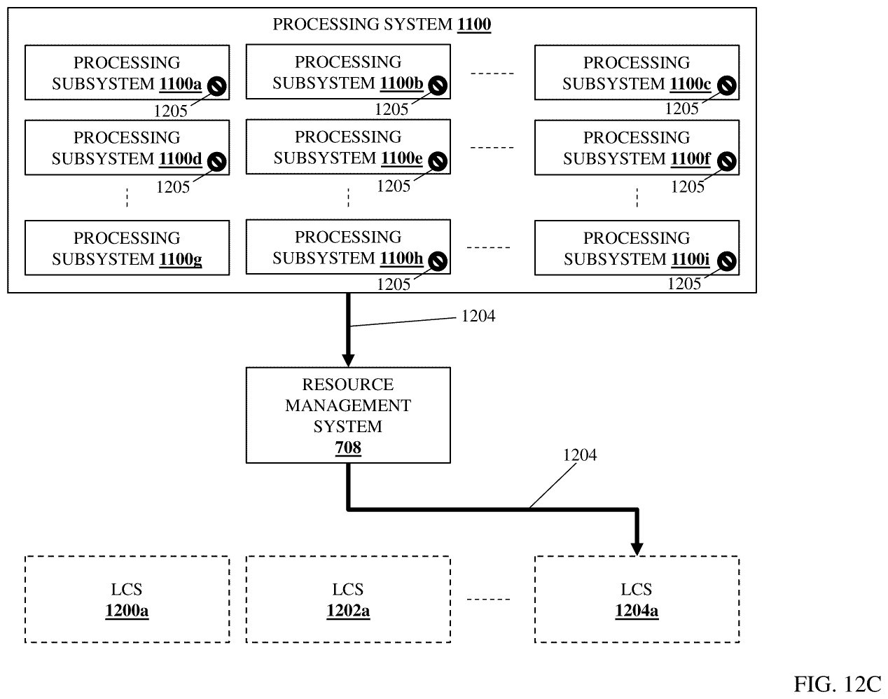

With reference to FIG. 12A, a specific example of a first iteration of the method 900 is illustrated in which an LCS is provided at block 904 following an LCS request received at decision block 902. In this specific example, the resource management system 706 may perform LCS provisioning operations 1200 that include providing an LCS 1200a similarly as described above, and one of skill in the art in possession of the present disclosure will appreciate how a variety of resource devices accessible to the resource management system 708 may be configured as part of the LCS provision operations 1200 to provide the LCS 1200a. In particular, with respect to the processing system configuration operations 1102 discussed above, the resource management system 708 may determine that the LCS request received at decision block 902 (e.g., the “workload intent” discussed above) requires the processing features provided by the processing subsystem 1100a, and may configure the processing subsystem 1100a in the processing system 1100 (e.g., the processor core in the CPU) to provide the LCS 1200a.

In some embodiments, the processing system configuration operations 1102 may include the configuration of a microvisor provided by the resource management system 708 to “assign” the processing subsystem 1100a to the LCS 1200a such that the microvisor is configured to route processing commands and/or responses between the processing subsystem 1100a, the client device 702 that requested the LCS 1200a, and/or the resource devices that provide the LCS 1200a, while isolating the LCS 1200a from the other processing subsystems 1100b-1100i (as illustrated by the elements 1201 in FIG. 12A). As such, one of skill in the art in possession of the present disclosure will appreciate how the processing system may be configured (e.g., by a processing system manufacturer) to allow for per-processing-subsystem-access-control via any of a variety of microvisor configuration operations that will fall within the scope of the present disclosure.

Following the processing system configuration operations 1102 and LCS provisioning operations 1200, processing operations for the LCS 1200a may only be performed by the processing subsystem 1100a in the processing system 1100. However, while a specific example of the initial provisioning of an LCS via a single processing subsystem is illustrated and described, one of skill in the art in possession of the present disclosure will appreciate how an LCS may initially be provided using multiple processing subsystems in one or more processing systems while remaining within the scope of the present disclosure as well.

Following block 904, or if no LCS request is received at decision block 902, the method 900 proceeds to decision block 906 where the method 900 proceeds depending on whether an LCS feature access request to provide access to a processing feature is received. As discussed in further detail below, during the method 900 and for any LCS provided by the resource management system 708, access may be requested to additional and/or different processing features that are not currently being provided by the processing subsystem(s) that are currently being used to provide that LCS. As such, in an embodiment of decision block 906, the resource management system 708 may monitor for such LCS feature access requests from the LCS(s), from the client device(s) for which it is providing those LCS(s), and/or from any other LCS feature access request source that would be apparent to one of skill in the art in possession of the present disclosure.

If, at decision block 906, no LCS feature access request is received, the method 900 returns to decision block 902. As such, the method 900 may loop such that the resource management system 708 provides LCS(s) at block 904 in response to LCS request(s) received at decision block 902 substantially as described above until an LCS feature access request is received at decision block 906.

To provide another specific example of blocks 902 and 904, with reference to FIG. 12B, a second iteration of the method 900 is illustrated in which an LCS is provided at block 904 following an LCS request received at decision block 902. In this specific example, the resource management system 706 may perform LCS provisioning operations 1202 that include providing an LCS 1202a similarly as described above, and one of skill in the art in possession of the present disclosure will appreciate how a variety of resource devices accessible to the resource management system 708 may be configured as part of the LCS provision operations 1202 to provide the LCS 1202a. In particular, with respect to the processing system configuration operations 1102 discussed above, the resource management system 708 may determine that the LCS request received at decision block 902 (e.g., the “workload intent” discussed above) requires the processing features provided by the processing subsystem 1100d, and may configure the processing subsystem 1100d in the processing system 1100 (e.g., the processor core in the CPU) to provide the LCS 1202a.

Similarly as described above, the processing system configuration operations 1102 may include the configuration of a microvisor provided by the resource management system 708 to “assign” the processing subsystem 1100d to the LCS 1202a such that the microvisor is configured to route processing commands and/or responses between the processing subsystem 1100d, the client device 702 that requested the LCS 1202a, and/or the resource devices that provide the LCS 1202a, while isolating the LCS 1202a from the other processing subsystems 1100a-1100c and 1100e-1100i (as illustrated by the elements 1203 in FIG. 12B). As such, one of skill in the art in possession of the present disclosure will appreciate how the processing system may be configured (e.g., by a processing system manufacturer) to allow for per-processing-subsystem-access-control via any of a variety of microvisor configuration operations that will fall within the scope of the present disclosure.

Following the processing system configuration operations 1102 and LCS provisioning operations 1202, processing operations for the LCS 1202a may only be performed by the processing subsystem 1100d in the processing system 1100. However, while a specific example of the initial provisioning of an LCS via a single processing subsystem is illustrated and described, one of skill in the art in possession of the present disclosure will appreciate how an LCS may initially be provided using multiple processing subsystems in one or more processing systems while remaining within the scope of the present disclosure as well.

To provide another specific example of blocks 902 and 904, with reference to FIG. 12C, an Nth iteration of the method 900 is illustrated in which an LCS is provided at block 904 following an LCS request received at decision block 902. In this specific example, the resource management system 706 may perform LCS provisioning operations 1204 that include providing an LCS 1204a similarly as described above, and one of skill in the art in possession of the present disclosure will appreciate how a variety of resource devices accessible to the resource management system 708 may be configured as part of the LCS provision operations 1204 to provide the LCS 1204a. In particular, with respect to the processing system configuration operations 1102 discussed above, the resource management system 708 may determine that the LCS request received at decision block 902 (e.g., the “workload intent” discussed above) requires the processing features provided by the processing subsystem 1100g, and may configure the processing subsystem 1100g in the processing system 1100 (e.g., the processor core in the CPU) to provide the LCS 1204a.

Similarly as described above, the processing system configuration operations 1102 may include the configuration of a microvisor provided by the resource management system 708 to “assign” the processing subsystem 1100g to the LCS 1204a such that the microvisor is configured to route processing commands and/or responses between the processing subsystem 1100g, the client device 702 that requested the LCS 1204a, and/or the resource devices that provide the LCS 1204a, while isolating the LCS 1204a from the other processing subsystems 1100a-1100f and 1100h-1100i (as illustrated by the elements 1205 in FIG. 12B). As such, one of skill in the art in possession of the present disclosure will appreciate how the processing system may be configured (e.g., by a processing system manufacturer) to allow for per-processing-subsystem-access-control via any of a variety of microvisor configuration operations that will fall within the scope of the present disclosure.

Following the processing system configuration operations 1102 and LCS provisioning operations 1204, processing operations for the LCS 1204a may only be performed by the processing subsystem 1100g in the processing system 1100. However, while a specific example of the initial provisioning of an LCS via a single processing subsystem is illustrated and described, one of skill in the art in possession of the present disclosure will appreciate how an LCS may initially be provided using multiple processing subsystems in one or more processing systems while remaining within the scope of the present disclosure as well.

Thus, one of skill in the art in possession of the present disclosure will appreciate how the LCSs 1200a, 1202a, and up to 1204a may be provided at block 904 using different processing subsystems 1100a, 1100d, and up to 1100g, respectively, in the same processing system 1100 (e.g., different processor cores in a CPU), as well as using any other resource devices required to provide those LCSs 1200a, 1202a, and up to 1204a, in order to enable the performance of workloads by those LCSs 1200a, 1202a, and up to 1204a that satisfy the “workload intent” expressed by the user(s) of the client device(s) 702.

Furthermore, one of skill in the art in possession of the present disclosure will appreciate how the isolation of each processing subsystem 1100a, 1100d, and up to 1100g for use by its respective LCS 1200a, 1202a, and up to 1204a operates to isolate the processing features available from that processing system for use only by the LCS it is providing. Thus, continuing with the specific example provided above, processing features available from the processing subsystem 1100a may be used by the LCS 1200a but not the LCSs 1202a and 1204a (e.g., the processor core in the CPU that provides the LCS 1200a will only process instructions for the client device 702 used to request that LCS 1200a and/or the other resource devices being used to provide that LCS 1200a), processing features available from the processing subsystem 1100c may be used by the LCS 1202a but not the LCSs 1200a and 1204a (e.g., the processor core in the CPU that provides the LCS 1202a will only process instructions for the client device 702 used to request that LCS 1202a and/or the other resource devices being used to provide that LCS 1202a), and processing features available from the processing subsystem 1100g may be used by the LCS 1204a but not the LCSs 1202a and 1202a (e.g., the processor core in the CPU that provides the LCS 1204a will only process instructions for the client device 702 used to request that LCS 1204a and/or the other resource devices being used to provide that LCS 1204a).

As such, an LCS provider (e.g., an entity that provides the LCS provisioning system 200 discussed above with reference to FIG. 2) may charge users of the resource devices in the LCS provisioning system 200 based on portions of those resource devices being used by the LCS being provided for that user. Continuing with the specific example provided above, the cost of a license for using the processing subsystems 1100a, 1100d, and up to 1100g in the processing system 1100 may be split between the users that requested the LCSs 1200a, 1202a, and up to 1204a. For example, the cost of a license to enable four processor cores in a CPU that provides the processing system 1100 may be split up and passed on to a user that requested the LCS 1200a (e.g., ¼ of that license for using the processor core provided by the processing subsystem 1100a), a user that requested the LCS 1202a (e.g., ¼ of that license for using the processor core provided by the processing subsystem 1100d), and a user that requested the LCS 1204a (e.g., ¼ of that license for using the processor core provided by the processing subsystem 1100g), with an added user benefit of not having to deal with the procuring and maintenance of that license (which is dealt with by the LCS provider).

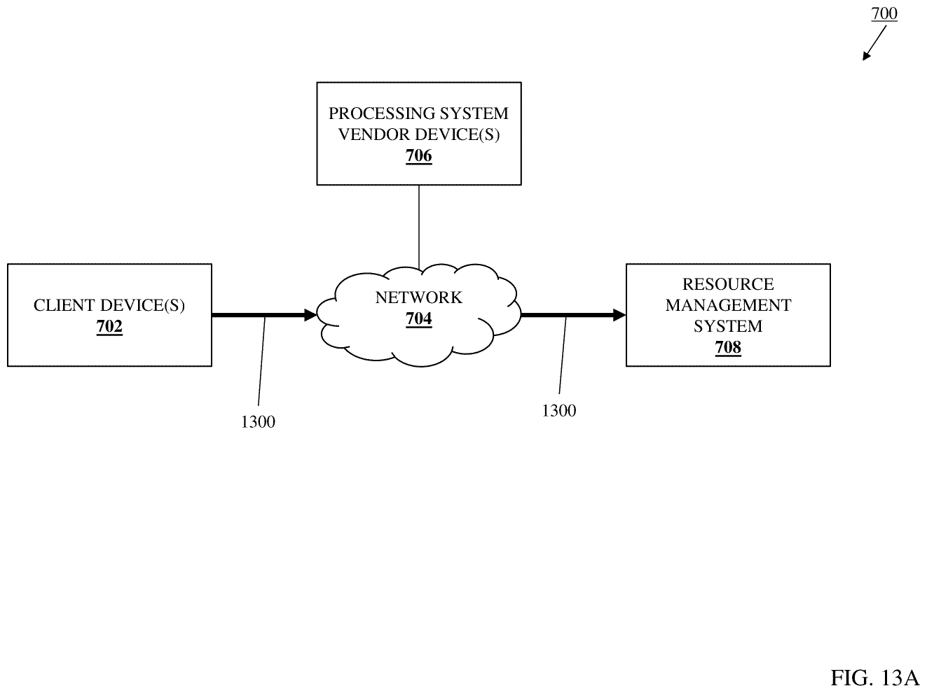

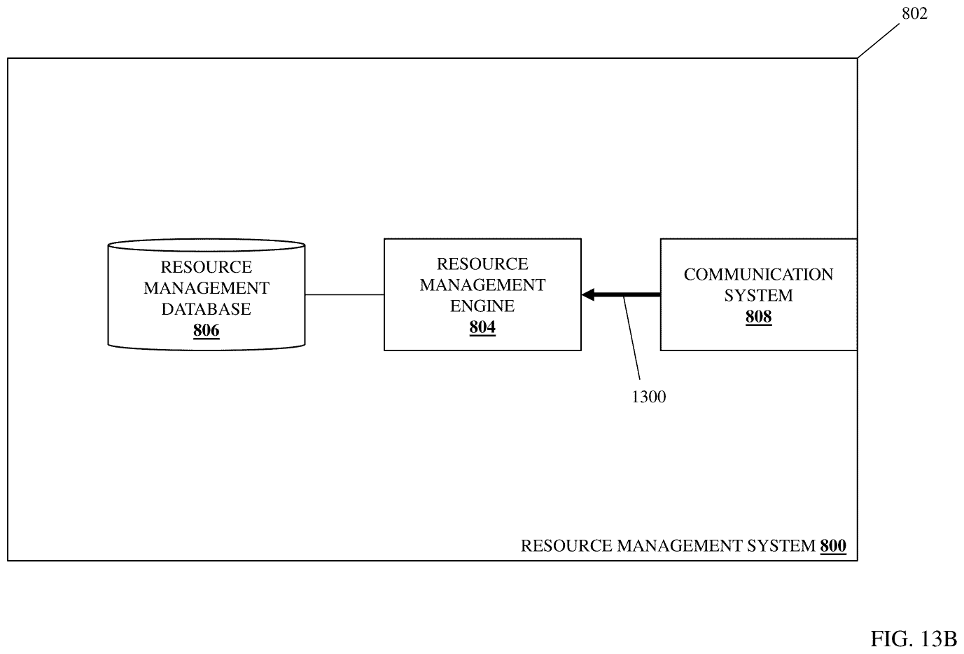

If, at decision block 906, an LCS feature access request is received, the method 900 proceeds to block 908 where the resource management system provides the LCS associated with the LCS feature access request using a different subset of processing subsystems in the processing system that provides access to the processing feature. As discussed above, at decision block 906, the resource management system 708 may monitor for LCS feature access requests from the LCS(s), from the client device(s) for which it is providing those LCS(s), and/or from any other LCS feature access request source that would be apparent to one of skill in the art in possession of the present disclosure. For example, with reference to FIG. 13A and in an embodiment of decision block 906, one of the client device(s) 702 may perform LCS feature access request transmission operations 1300 that include transmitting an LCS feature access request for the LCS it is being provided (e.g., the LCS 1200a in the examples provided below) via the network 704 such that the resource management engine 804 in the resource management system 708/800 receives that LCS feature access request via its communication system 808.

In some examples, the LCS feature access request provided by one of the client device(s) 702 at decision block 906 may include an explicit request for processing features that are not available from the processing subsystem(s) being used to provide its LCS (e.g., processing features not available from the processing subsystem 1100a providing the LCS 1200a), and may be similar to the “workload intent” used to request LCSs as described above (e.g., “I need a processor accelerator for my LCS”). In other examples, the LCS feature access request may be provided by one of the client device(s) 702 and/or the LCS being provided for that client device and may include an implicit request for processing features that are not available from the processing subsystem(s) being used to provide that LCS (e.g., processing features not available from the processing subsystem 1100a providing the LCS 1200a) that may include any instruction, operation, or other processing subsystem functionality that requires that processing feature. To provide a specific example, a client device instruction, LCS operation, or other client device/LCS functionality that requires the use of a processor accelerator feature that is not available from the processing subsystem 1100a may provide an LCS feature access request for the LCS 1200a for that processor accelerator feature. However, while two specific examples of LCS feature access requests have been provided, one of skill in the art in possession of the present disclosure will appreciate how the LCS feature access requests may be provided in a variety of manners that will fall within the scope of the present disclosure as well.

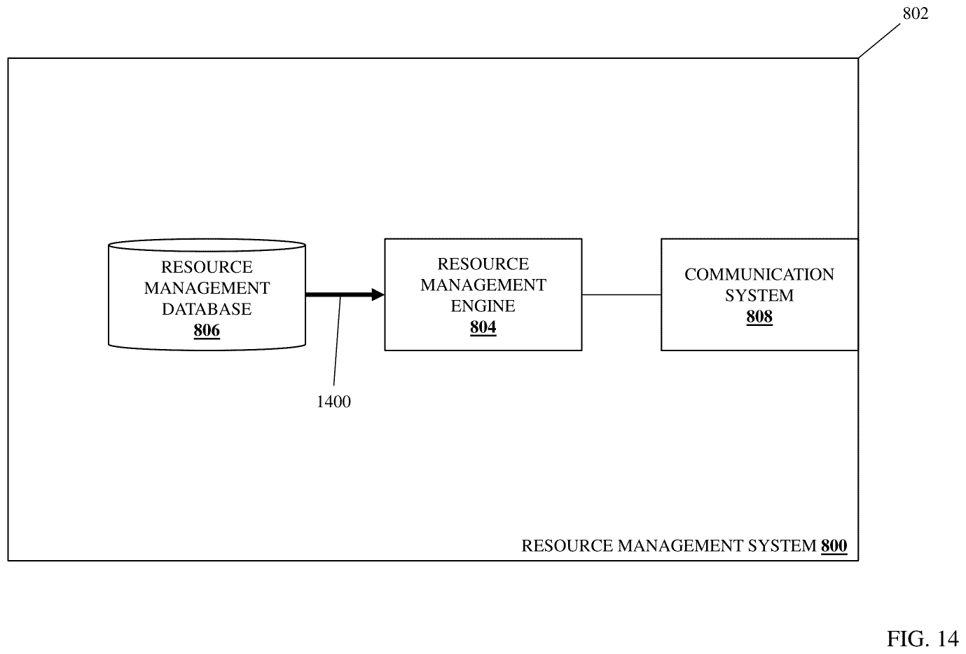

With reference to FIG. 14, in an embodiment of block 908 and in response to receiving the LCS feature access request at decision block 906, the resource management engine 804 may perform LCS feature access request authorization operations 1400 that may include accessing the resource management database 806 to attempt to authorize the activation of the processing feature for the LCS that was requested in the LCS feature access request. For example, the LCS feature access request authorization operations 1400 may include accessing one or more policies stored in the resource management database 806 to determine whether the activation of the processing feature for the LCS that was requested in the LCS feature access requested at decision block 906 is allowable based on those policies. As will be appreciated by one of skill in the art in possession of the present disclosure, the LCS provider may define any of a variety of policies about the activation of processing features for LCSs provided via the LCS provisioning system 200, and thus the processing feature requested for activation for the LCS in the LCS feature access request may be required to satisfy any corresponding policies before it may be activated as described below.

Furthermore, one of skill in the art in possession of the present disclosure will also appreciate how a user of the client device(s) 702 may define any of a variety of policies in the resource management database 806 that may dictate whether processing features for LCSs provided via the LCS provisioning system 200 for that user may be activated as well. To provide a specific example, a user of the client device(s) 702 may define a power usage policy that “caps” or otherwise provides a maximum power usage for LCSs provided for that user, and thus the processing feature requested for activation for the LCS in the LCS feature access request may be required to satisfy that power usage policy (e.g., with regard to other LCSs that may also be currently provided for that user) before it may be activated as described below.

Furthermore, one of skill in the art in possession of the present disclosure will appreciate how the LCS feature access request authorization operations 1400 performed by the resource management engine 804 may modify the provisioning of LCSs for a user in order to satisfy policies required to activate the processing feature for the LCS requested in the LCS feature access request. For example, continuing with the power usage policy described in the specific example provided above, the resource management engine 804 may identify one or more processing features that are not currently being used by the LCSs being provided to a user, and may disable those processing features in order to reduce the power consumption by those LCSs in a manner that will allow the activation of the processing feature for the LCS requested in the LCS feature access request while satisfying the power usage policy. However, while the application of a specific user-defined policy, as well as the performance of specific operations to satisfy that user-defined policy, have been described, one of skill in the art in possession of the present disclosure will appreciate how a variety of user-defined policies, and operations to satisfy those user-defined policies, will fall within the scope of the present disclosure as well.

In the event the processing feature requested for the LCS in the LCS feature access request is allowable by policy, the LCS feature access request authorization operations 1400 may also include retrieving a license that is configured to activate that processing feature. For example, the resource management database 806 may store a license for the processing system 1100 that is configured to activate a processor accelerator provided by the processing subsystem 1100b and requested in the LCS feature access request, and the resource management engine 804 may retrieve that license as part of the LCS feature access request authorization operations 1400 at block 908. However, while a specific example of the retrieval of a license to activate a processing feature has been described, one of skill in the art in possession of the present disclosure will appreciate how licenses to activate processing features may be retrieved in a variety of manners that will fall within the scope of the present disclosure as well.

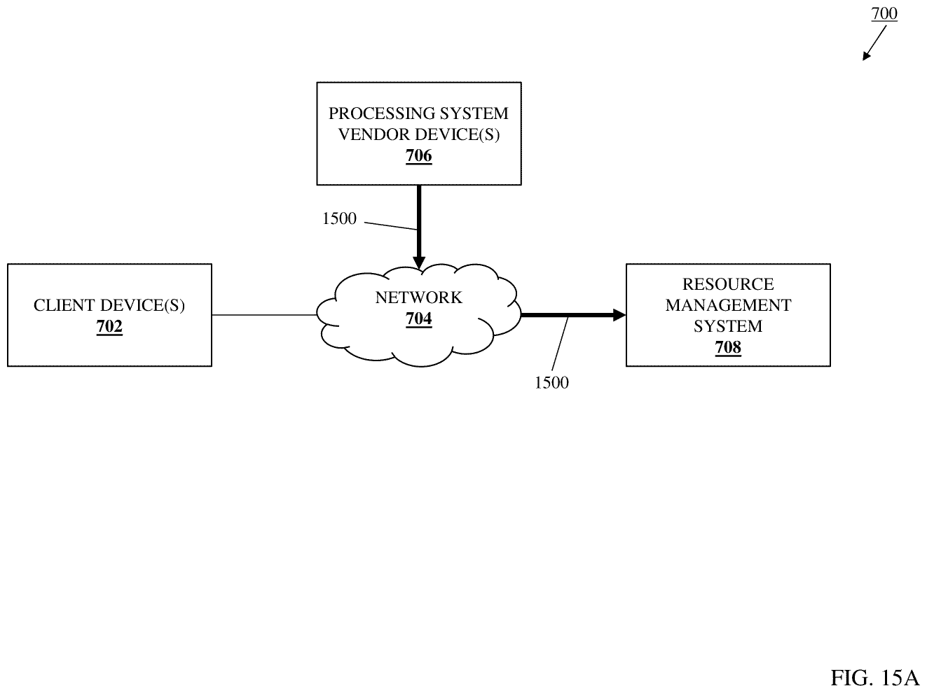

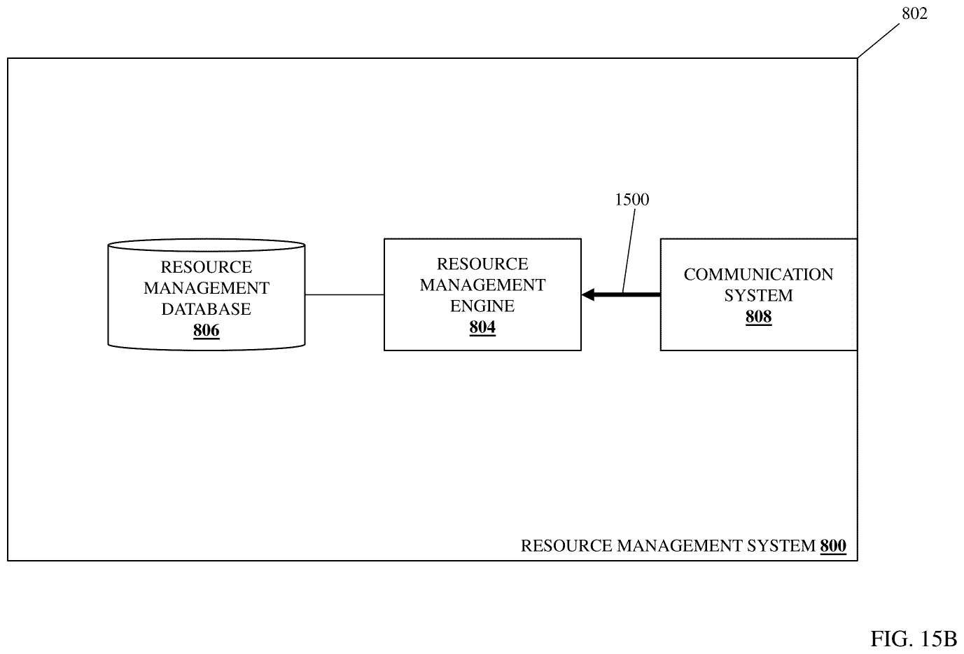

For example, with reference to FIGS. 15A and 15B, in other embodiments and in the event the processing feature requested for the LCS in the LCS feature access request is allowable by policy, the resource management engine 804 in the resource management system 708/800 may perform LCS feature access request authorization operations 1500 that may include the resource management engine 804 in the resource management system 708/800 retrieving a license that is configured to activate that processing feature via its communication system 808 and the network 704 from one of the processing system vendor device(s) 706. For example, one of the processing system vendor device(s) 706 may store a license for the processing system 1100 that is configured to activate a processor accelerator provided by the processing subsystem 1100b (i.e., processing features of the processing system 1100 may be enabled via licenses from the processing system vendor of the processing system 1100), and the resource management engine 804 may retrieve that license as part of the LCS feature access request authorization operations 1500 at block 908.

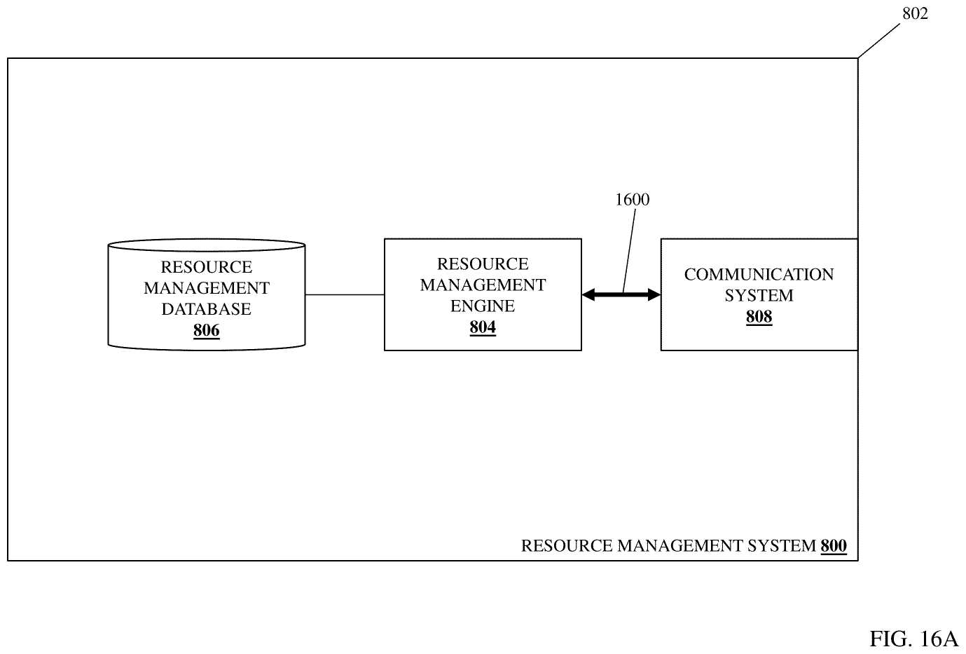

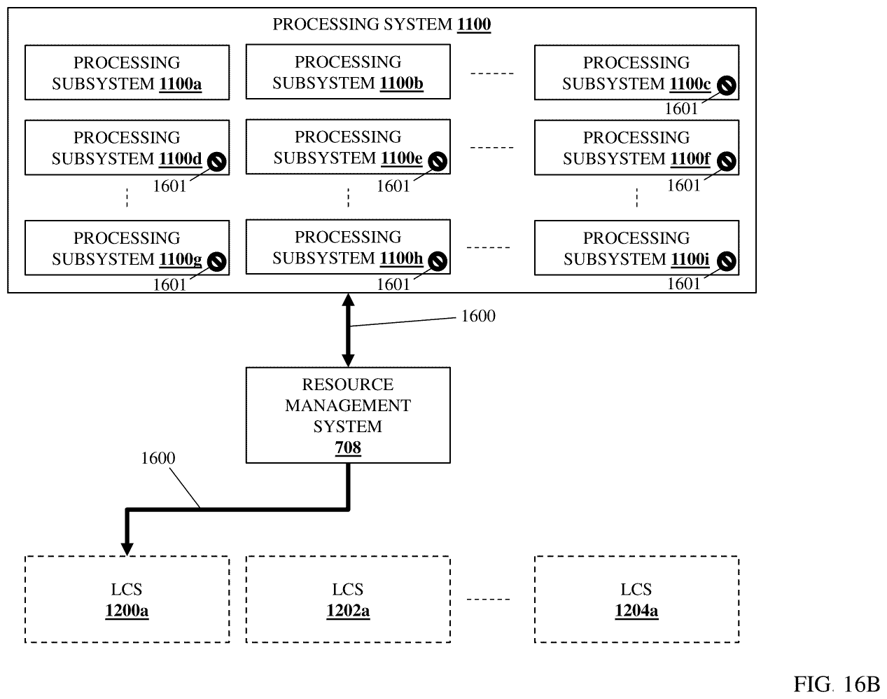

With reference to FIGS. 16A and 16B, at block 908, the resource management system 800 may then perform LCS feature access activation operations 1600 that, in the illustrated embodiment, include configuring the processing subsystem 1100b in the processing system 1100 (e.g., a processor accelerator in the CPU) to provide the LCS 1200a along with the processing subsystem 1100a. Similarly as described above, the LCS feature access activation operations 1600 may include the configuration of a microvisor provided by the resource management system 708 to enable access to the processing subsystem 1100b by the LCS 1200a (e.g., using the license retrieved as described above), and “assigning” the processing subsystem 1100b to the LCS 1200a such that the microvisor is configured to route processing commands and/or responses between the processing subsystem 1100b, the client device 702 that requested the LCS 1200a, and/or the resource devices that provide the LCS 1200a, while isolating the LCS 1200a from the other processing subsystems 1100c-1100i (as illustrated by the elements 1601 in FIG. 16B). As such, one of skill in the art in possession of the present disclosure will appreciate how the processing system may be configured (e.g., by a processing system manufacturer) to allow for per-processing-subsystem-access-control via any of a variety of microvisor configuration operations that will fall within the scope of the present disclosure.

As such, following the LCS feature access activation operations 1600, processing operations for the LCS 1200a may only be performed by the processing subsystem 1100a and the processing subsystem 1100b in the processing system 1100. However, while a specific example of the subsequent provisioning of an LCS by a pair of processing subsystem following an LCS feature access request is illustrated and described, one of skill in the art in possession of the present disclosure will appreciate how an LCS may subsequently be provided using different numbers of processing subsystems in one or more processing systems while remaining within the scope of the present disclosure as well.

The method 908 then returns to decision block 902. As such, the method 900 may loop such that LCSs are initially provided using processing subsystems at blocks 902 and 904, and then any of those LCSs may be subsequently provided using additional and/or other processing subsystems at blocks 906 and 908 to access additional processing feature that were not available from the processing subsystems that were initially used to provide those LCSs. Furthermore, in some embodiments, the resource management system 708/800 may operate to subsequently revoke access by LCSs to processing subsystems/processing features that were provided for those LCSs at blocks 906 and 908. For example, in some embodiments the license for a processing feature provided by the processing system 1100 may be configured to expire based on time, a number of uses of the processing feature/processing system, and/or based on any other license expiration metrics that would be apparent to one of skill in the art in possession of the present disclosure. As will be appreciated by one of skill in the art in possession of the present disclosure, a user of an LCS may be provided the opportunity to extend access to such processing features/processing subsystems (e.g., by paying for such continued access) in order to avoid the LCS feature access revocation operations discussed below and allow its LCS to continue to access such processing features/processing subsystems.

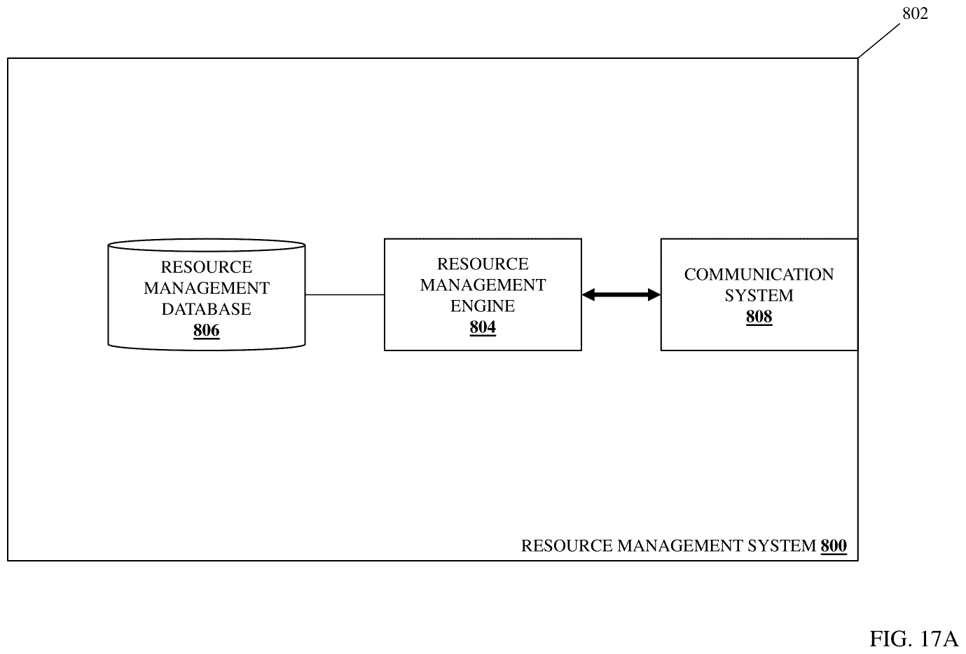

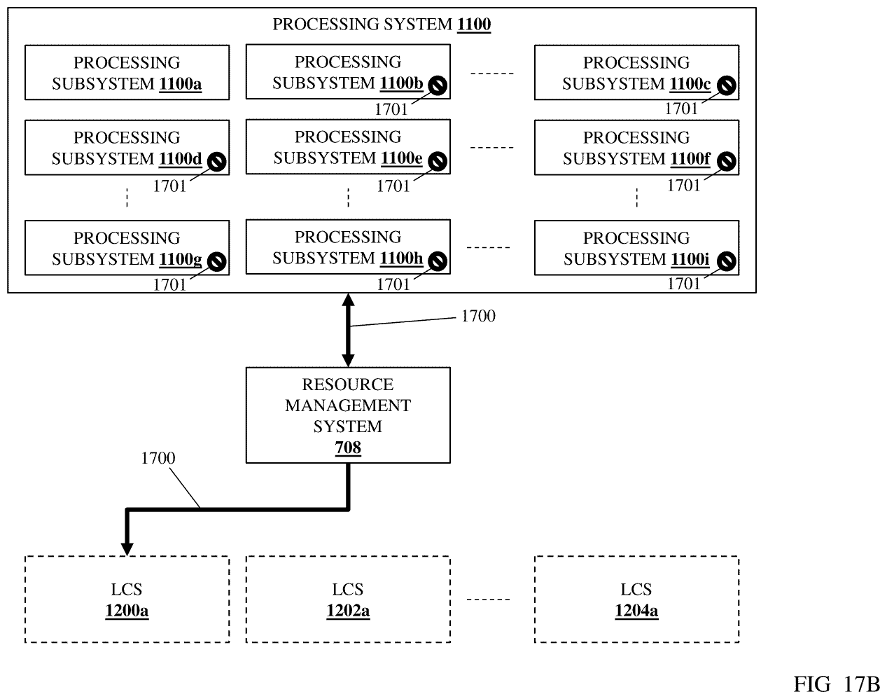

As such, in some embodiments the resource management engine 804 in the resource management system 708/800 may be configured to monitor the access period to a processing feature/processing subsystem by an LCS (e.g., an access period for the processing subsystem 1100b by the LCS 1200a according to a license in the specific example provided above) and, in the event that access period expires, the resource management engine 804 may revoke access to that processing feature/processing subsystem. For example, with reference to FIGS. 17A and 17B and in response to the license for the processing subsystem 1100b expiring, the resource management system 800 may perform LCS feature access revocation operations 1700 that, in the illustrated embodiment, include configuring the processing system 1100 to prevent access to the processing subsystem 1100b (e.g., a processor accelerator in the CPU) by the LCS 1200a.

Similarly as described above, the LCS feature access revocation operations 1700 may include the configuration of a microvisor provided by the resource management system 708 to prevent access to the processing subsystem 1100b by the LCS 1200a such that the microvisor is only configured to route processing commands and/or responses between the processing subsystem 1100a, the client device 702 that requested the LCS 1200a, and/or the resource devices that provide the LCS 1200a, while isolating the LCS 1200a from the other processing subsystems 1100b-1100i (as illustrated by the elements 1701 in FIG. 17B). As such, one of skill in the art in possession of the present disclosure will appreciate how the processing system may be configured (e.g., by a processing system manufacturer) to allow for per-processing-subsystem-access-control via any of a variety of microvisor configuration operations that will fall within the scope of the present disclosure.

As such, following the LCS feature access revocation operations 1700, processing operations for the LCS 1200a may only be performed by the processing subsystem 1100a in the processing system 1100. However, while a specific example of the revocation of access to a processing subsystem by an LCS is illustrated and described, one of skill in the art in possession of the present disclosure will appreciate how processing feature/processing subsystem access revocation for an LCS may be performed in a variety of manners while remaining within the scope of the present disclosure as well. For example, a user of an LCS may request the revocation of access to processing features/processing subsystems while remaining within the scope of the present disclosures as well. Furthermore, the resource management engine 804 in the resource management system 708/800 may be configured to identify processing subsystems that are unused by LCSs for some time period, and then revoke access to those processing subsystems similarly as described above.

As such, one of skill in the art in possession of the present disclosure will appreciate how the LCS processing feature access control system described above may be implemented in the LCS provisioning system 200 described above to provide LCS Si-aaS without the need for processing system providers to directly enable such Si-aaS functionality. Furthermore, the LCS processing feature access control system described above allows the LCS provider of the LCS provisioning system 200 to bill users of the client device(s) 702 for the use of processing features “on-demand”. For example, when the LCS feature access requests for processing features are provided by the implicit requests discussed above that can include any instruction, operation, or other processing subsystem functionality that requires that processing feature, the use of a corresponding processing subsystem to provide that processing feature for an LCS may result in the setting of a flag for that processing subsystem in the processing system 1100 (e.g., a CPU flag) by the microvisor, with those flag(s) remaining for the life of the LCS and utilized to bill the user of that LCS for the use of the corresponding processing feature(s). As such, the enablement of additional processing features for LCSs and their use by those LCSs as described above may be automated.

Thus, systems and methods have been described that provide for the provisioning of multiple LCSs using different processing subsystems in a processing system, as well as the enablement of processing features for any of those LCSs “on-demand” via modification of the subset of processing subsystems in the processing system used to provide that LCS. For example, the LCS processing feature access control system of the present disclosure may include a resource management system coupled to a processing system including a plurality of processing subsystems. The resource management system receives a first LCS request to provide a first LCS, and provides the first LCS using a first subset of the processing subsystems. The resource management system also receives a second LCS request to provide a second LCS, and provides the second LCS using a second subset of the processing subsystems that is different than the first subset of the processing subsystems, The resource management system then receives a first LCS feature access request to provide access for the first LCS to a processing feature that is not available via the first subset of the processing subsystems, and provides the first LCS using a third subset of the processing subsystems that is different than the first subset and that provides the processing feature. As such, processing system service features like Si-aaS may be utilized for processing system that provide multiple LCSs, allowing users to be provided (and only be charged for) processing features required to provide their LCSs.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A Logically Composed System (LCS) processing feature access control system, comprising:
a processing system including a plurality of processing subsystems; and
a resource management system that is coupled to the processing system and that is configured to:
receive a first Logically Composed System (LCS) request to provide a first LCS;
provide, in response to receiving the first LCS request, the first LCS using a first subset of the plurality of processing subsystems;
receive a second LCS request to provide a second LCS;
provide, in response to receiving the second LCS request, the second LCS using a second subset of the plurality of processing subsystems that is different than the first subset of the plurality of processing subsystems;
receive a first LCS feature access request to provide access for the first LCS to a processing feature that is not available via the first subset of the plurality of processing subsystems; and
provide, in response to receiving the first LCS feature access request, the first LCS using a third subset of the plurality of processing subsystems that is different than the first subset of the plurality of processing subsystems and that provides the processing feature.

2. The system of claim 1, wherein the resource management system includes a microvisor.

3. The system of claim 1, wherein the resource management system is configured to:
determine that an access period by the first LCS to the processing feature provided by the third subset of the plurality of processing subsystems has expired; and
provide, in response to determining that the access period has expired, the first LCS using a first subset of the plurality of processing subsystems.

4. The system of claim 1, wherein the plurality of processing subsystems include a plurality of processor cores.

5. The system of claim 1, wherein the plurality of processing subsystems include a plurality of processor accelerators.

6. The system of claim 1, wherein the providing the first LCS using the third subset of the plurality of processing subsystems that provides the processing feature includes:
retrieving a processing system license that is configured to enable access to the processing feature in the processing system; and
enabling, in the processing system using the processing system license, the processing feature via the third subset of the plurality of processing subsystems.

7. An Information Handling System (IHS), comprising:
a resource management processing system; and
a resource management memory system that is coupled to the resource management processing system and that includes instructions that, when executed by the resource management processing system, cause the resource management processing system to provide a resource management engine that is configured to:
receive a first Logically Composed System (LCS) request to provide a first LCS;
provide, in response to receiving the first LCS request, the first LCS using a first subset of a plurality of processing subsystems in a Central Processing Unit (CPU);
receive a second LCS request to provide a second LCS;
provide, in response to receiving the second LCS request, the second LCS using a second subset of the plurality of processing subsystems that is different than the first subset of the plurality of processing subsystems;
receive a first LCS feature access request to provide access for the first LCS to a processing feature that is not available via the first subset of the plurality of processing subsystems; and
provide, in response to receiving the first LCS feature access request, the first LCS using a third subset of the plurality of processing subsystems that is different than the first subset of the plurality of processing subsystems and that provides the processing feature.

8. The IHS of claim 7, wherein the resource management engine includes a microvisor.

9. The IHS of claim 7, wherein the resource management engine is configured to:
determine that an access period by the first LCS to the processing feature provided by the third subset of the plurality of processing subsystems has expired; and
provide, in response to determining that the access period has expired, the first LCS using a first subset of the plurality of processing subsystems.

10. The IHS of claim 7, wherein the plurality of processing subsystems include a plurality of processor cores in the CPU.

11. The IHS of claim 7, wherein the plurality of processing subsystems include a plurality of processor accelerators in the CPU.

12. The IHS of claim 7, wherein the providing the first LCS using the third subset of the plurality of processing subsystems that provides the processing feature includes:
retrieving a CPU license that is configured to enable access to the processing feature in the CPU; and
enabling, in the CPU using the CPU license, the processing feature via the third subset of the plurality of processing subsystems.

13. The IHS of claim 7, wherein the license is retrieved from a CPU vendor device via a network.

14. A method controlling access to processing features for a Logically Composed System (LCS), comprising:
receiving, by a resource management system, a first Logically Composed System (LCS) request to provide a first LCS;
providing, by the resource management system in response to receiving the first LCS request, the first LCS using a first subset of a plurality of processing subsystems in a processing system;
receiving, by the resource management system, a second LCS request to provide a second LCS;
providing, by the resource management system in response to receiving the second LCS request, the second LCS using a second subset of the plurality of processing subsystems that is different than the first subset of the plurality of processing subsystems;
receiving, by the resource management system, a first LCS feature access request to provide access for the first LCS to a processing feature that is not available via the first subset of the plurality of processing subsystems; and
providing, by the resource management system in response to receiving the first LCS feature access request, the first LCS using a third subset of the plurality of processing subsystems that is different than the first subset of the plurality of processing subsystems and that provides the processing feature.

15. The method of claim 14, wherein the resource management engine includes a microvisor.

16. The method of claim 14, further comprising:
determining, by the resource management system, that an access period by the first LCS to the processing feature provided by the third subset of the plurality of processing subsystems has expired; and
providing, by the resource management system in response to determining that the access period has expired, the first LCS using a first subset of the plurality of processing subsystems.

17. The method of claim 14, wherein the plurality of processing subsystems include a plurality of processor cores in the processing system.

18. The method of claim 14, wherein the plurality of processing subsystems include a plurality of processor accelerators in the processing system.

19. The method of claim 14, wherein the providing the first LCS using the third subset of the plurality of processing subsystems that provides the processing feature includes:
retrieving a CPU license that is configured to enable access to the processing feature in the processing system; and
enabling, in the CPU using the CPU license, the processing feature via the third subset of the plurality of processing subsystem.

20. The method of claim 14, wherein the license is retrieved from a processing system vendor device via a network.
